(19) United States
(12) Patent Application Publication
(10) Pub. No.: US 2026/0138069 A1
(43) Pub. Date: May 21, 2026

(54) FILTER DEVICE WITH A FILTER MEDIUM COMPRISING AN ELECTRICALLY CONDUCTIVE MATERIAL

(71) Applicant: CABINAIR SWEDEN AB, Stockholm (SE)

(72) Inventor: Lars Wettre, Stockholm (SE)

(21) Appl. No.: 19/119,685

(22) PCT Filed: Oct. 9, 2023
(86) PCT No.: PCT/EP2023/077923

§ 371 Date: Apr. 9, 2025

(30) Foreign Application Priority Data
Oct. 10, 2022 (SE) SE 2251182-8

(51) Int. Cl. B01D 46/00; B01D 46/52

(52) U.S. Cl. CPC B01D 46/0032; B01D 46/521; B01D 2275/10

(57) ABSTRACT

The present invention relates to a filter device (F) for filtration of an air flow (A). Said filter device (F) comprises a filter medium (30), said filter medium comprising an electrically conductive material. Said filter device (F) further comprises a filter connection device comprising an electrically conductive material. Said filter connection device comprises at least one clamp member (40) being configured to be conductively attachable to a conductive portion of said filter medium (30) so that, when said at least one clamp member (40) is attached to said filter medium (30), said filter medium (30), by means of said filter connection device is allowed to be removably electrically connectable to at least one electrically conductive portion of an electric device (U) so as to, when electrically connected, facilitate an air purification operation.

### TECHNICAL FIELD

The present invention relates to filter device with a filter medium comprising an electrically conductive material. The present invention also relates to an electric device for electrical connection to such a filter device. The present invention also relates to an air purification device comprising such a filter device and electric device.

### BACKGROUND

Within many different technical fields, like for example different types of vehicles or buildings, air filtration systems are used to ensure the desired air quality within the cabin or building or other closed space.

Such filtration systems may comprise a filter device comprising a particle filter layer and an electrically conductive filter layer. Such filtration systems may further comprise an electric device, where the electric device may be an ionizing unit configured to ionize particles in the air to be purified in order to increase the filter performance. Such an electric device may be electrically connected to the filter device for facilitating an air purification operation.

US 2021162331 A1 discloses a filter element with a filter medium having a particle filter layer and an electrically conductive filter layer, where the filter element comprises an electrically conductive edge band connected to an outer side of the filter medium, where said edge band forms a pocket open towards one side. Said pocket is configured to receive a blade of an electronic control unit.

### OBJECTS OF THE INVENTION

An object of the present disclosure is to provide a filter device with a filter medium comprising an electrically conductive material, which facilitates safe, easy and efficient electrical connection to an electric device for air purification operation, and safe, easy and efficient removal of said filter device from said electric device.

Another object of the present invention is to provide an electric device for electrical connection to such a filter device.

Another object of the present invention is to provide an air purification device comprising such a filter device and electric device.

### SUMMARY

These and other objects, apparent from the following description, are achieved by a filter device, an electric device and an air purification device, as set out in the appended independent claim. Preferred embodiments of the filter device and electric device are defined in appended dependent claims.

Specifically, an object of the invention is achieved by a filter device for filtration of an air flow, said filter device comprising: a filter medium, said filter medium comprising an electrically conductive material; and, a filter connection device comprising an electrically conductive material, said filter connection device comprising at least one clamp member being configured to be conductively attachable to a conductive portion of said filter medium so that, when said at least one clamp member is attached to said filter medium, said filter medium, by means of said filter connection device is allowed to be removably electrically connectable to at least one electrically conductive portion of an electric device so as to, when electrically connected, facilitate an air purification operation.

The electric device may be any electric device suitable for air purification operation by means of a filter medium. According to an aspect of the present disclosure, the electric device is an electric device for a filter medium comprising an electrically conductive material, wherein said electric device may be denoted electric filter device. According to an aspect of the present disclosure, the electric device is an electric device associated with air purification operation by means of a filter device comprising an electrically conductive material. According to an aspect of the present disclosure, the electric device is an electric device configured to be comprised in an air purification device comprising said filter device.

Hereby safe, easy and efficient electrical connection to an electric device for air purification operation, and safe, easy and efficient removal of said filter device from said electric device is facilitated. Hereby safe, easy and efficient electrical connection to and removal from an electric device fixedly arranged within a space of an air duct is facilitated. Hereby safe, easy and efficient exchange of the filter device, e.g. filter medium of said filter device, is facilitated without having to remove the electric device or parts of the electric device.

According to an aspect of the filter device, said filter medium has an inflow side configured, during an air purification operation, to face towards the flow of air and an opposite outflow side. When the filter device is electrically connected to an electric device and arranged within a space of an air duct, said direction of the flow of air towards the inflow side and said direction of the flow of air from the outflow side after having passed said filter medium may vary and may according to an aspect depend on the configuration of the air duct within which air is arranged to flow during an air purification operation. Thus, according to an aspect, the direction of the flow of air towards the inflow side may have any suitable angle. Thus, according to an aspect, the direction of the flow of air from the outflow side may have any suitable angle.

According to an aspect, said filter device is configured to be removably introduced via an opening into a compartment of an air duct, wherein said at least one clamp member is configured to be attached to said filter medium so that said filter connection device aligns with and electrically connects to said at least one electrically conductive portion of said electric device, said electric device being fixedly arranged within said air duct. Hereby safe, easy and efficient electrical connection to an electric device for air purification operation, and safe, easy and efficient removal of said filter device from said electric device is facilitated.

According to an aspect, said filter device has an essentially plane main extension, wherein said at least one clamp member is configured to be attached to said filter medium so that said filter device may be introduced, by moving the filter device in the direction of its main extension, into said compartment of said air duct, for facilitating said electrical connection to said at least one electrically conductive portion of said electric device, and removed from said compartment by moving said filter device in the direction of its main extension so that said at least one clamp member of said filter device is disconnected from said at least one electrically conductive portion of said electric device. Hereby safe, easy and efficient electrical connection to an electric device for air purification operation, and safe, easy and efficient removal of said filter device from said electric device is facilitated. According to an aspect of the present disclosure, said at least one clamp member is configured to be attached to said filter medium so that said filter device may be introduced, by moving the filter device in the direction of its main extension, into said compartment of said air duct, downstream of said electric device arranged within said compartment for facilitating said electrical connection to said at least one electrically conductive portion of said electric device. According to an aspect of the present disclosure, the configuration and shape of the filter device is adapted to the opening of the air duct through which it is configured to be introduced and the space within the air duct where it is configured to be arranged during air purification operation, when electrically connected to an electric device. The filter device may have any suitable geometrical shape such as square, rectangular, circular, triangular, pentagonal, hexagonal etc. According to an aspect of the present disclosure, the filter device has a certain length, a certain width and a certain height. According to an aspect the height corresponds to the distance between the inflow side and outflow side. According to an aspect of the present disclosure, said width and length has a main extension essentially orthogonal to the height. The filter medium of the filter device may have any suitable configuration such as a pleated configuration or a flat configuration, i.e. a configuration without pleats. The filter medium of the filter device may have any suitable geometrical shape such as square, rectangular, circular, triangular, pentagonal, hexagonal etc. According to an aspect of the present disclosure, the filter medium has a certain length, a certain width and a certain height. According to an aspect the height corresponds to the distance between the inflow side and outflow side. According to an aspect of the present disclosure, said width and length has a main extension essentially orthogonal to the height.

According to an aspect of the filter device, said at least one clamp member comprises a conductive contact portion having a contact surface configured to facilitate conductive connection to said electrically conductive portion of said electric device. Hereby easy and efficient electrical connection to a conductive portion/part of an electric device is facilitated. Said clamp member is according to an aspect made of a conductive material. According to an aspect of the present disclosure, at least parts of the clamp member are conductive so as to provide connection with conductive material of the filter medium and facilitate conductive connection with conductive portion/part of an electric device.

According to an aspect of the filter device, said at least one clamp member comprises a grip portion configured to facilitate attachment and conductive connection of said at least one clamp member to said filter medium. Hereby the filter medium of the filter device may be easily and efficiently provided with said at least one clamp member. According to an aspect of the present disclosure, said grip portion of said at least one clamp member is configured to be operable between a non-grip position and a grip position so as to facilitate attachment to said filter medium. According to an aspect of the present disclosure, said grip portion of said at least one clamp member comprises one or more retention members configured to facilitate retention of said at least one clamp member to said filter medium when said clamp member is attached to said filter medium.

According to an aspect of the filter device, said at least one clamp member has resilient properties so as to strive towards said at least one electrically conductive portion of an electric device, when arranged in connection to said electric device. Hereby electrical connection to said electric device may be easily and efficiently maintained during an air purification operation. According to an aspect of the filter device, said at least one clamp member has resilient properties so as to strive towards said at least one electrically conductive portion of an electric device, when arranged in connection to said electric device within a space of an air duct.

According to an aspect of the present disclosure, said at least one clamp member has resilient properties so as to facilitate attachment to said filter medium and, where applicable, removal from said filter medium. Hereby easy attachment of said at least one clamp member to and removal from said filter medium is facilitated.

According to an aspect of the filter device, said grip portion of said at least one clamp member comprises one or more conductive pins configured to provide conductive connection to conductive parts of said filter medium when attached to the filter medium. Hereby efficient conductive connection to conductive parts of said filter medium is facilitated. According to an aspect of the present disclosure, said one or more conductive pins constitute or comprise said retention members. According to an aspect of the present disclosure, said one or more conductive pins comprises retention members, where said retention members of said one or more conductive pins according to an aspect are constituted by one or more barbs on one or more of said one or more pins.

According to an aspect of the filter device, said filter medium comprises at least two layers, said at least two layers comprising a first filter layer, and a second layer, said second layer being an electrically conductive layer provided by said electrically conductive material of said filter medium, said at least one clamp member being configured to be conductively attachable to said electrically conductive layer. According to an aspect of the present disclosure, said first filter layer is the layer on the inflow side. According to an aspect of the present disclosure, said first filter layer is a particle filter layer configured to provide filtration of particles in the flow of air during an air purification operation. According to an aspect of the present disclosure, said filter medium comprises a third filter layer, wherein said second filter layer, being an electrically conductive layer, is configured to be arranged between said first filter layer and third filter layer. According to an aspect of the present disclosure, said electrically conductive layer is configured to provide at least some particle filtration during an air purification operation. According to an aspect of the present disclosure, said third filter layer is a particle filter layer configured to provide filtration of particles in the flow of air during an air purification operation. Said filter medium may have any suitable number of filter layers, said filter layers comprising one or more particle filter layers and one or more electrically conductive layers. According to an aspect, one or more filter layers of said filter medium may be configured to protect and/or support said one or more electrically conductive layer(s). According to an aspect of the present disclosure, said at least one clamp member is configured to be conductively attachable to said electrically conductive layer via said first filter layer. According to an aspect of the present disclosure, said at least one clamp member is configured to be conductively attachable to said electrically conductive layer via said first filter layer and/or said third filter layer. According to an aspect of the present disclosure, the filter medium may comprise more than one conductive layer, e.g. two conductive layers, separated from each other.

According to an aspect of the filter device, said filter medium has a pleated configuration with a set of pleats, wherein said at least one clamp member is configured to be attachable to one or more of said set of pleats of said filter medium. Hereby efficient filtration is facilitated. Hereby easy and efficient attachment of said one or more clamp members is facilitated.

According to an aspect of the filter device, said filter medium has a flat configuration, where said inflow side and opposite outflow side are configured to provide essentially flat surfaces, wherein said at least one clamp member is configured to be attachable at said inflow side and/or said outflow side of said filter medium.

According to an aspect of the filter device, at least one of said at least one clamp member is configured to be attached on said inflow side of said filter medium. Hereby is facilitated easy electrical connection to an electrically conductive portion of an electric device configured to be arranged upstream of said filter device during an air purification operation. According to an aspect of the present disclosure, said at least one of said at least one clamp member is configured to be attached on said outflow side of said filter medium. According to an aspect of the present disclosure, at least one of said at least one clamp members is configured to be attached on said inflow side of said filter medium and at least one of said at least one clamp members is configured to be arranged on the outflow side of said filter medium.

According to an aspect of the filter device, said filter device comprises an edge member configured to at least partly surround said filter medium. Hereby said filter medium may be efficiently supported and held together. Hereby said filter device may be easily and efficiently arranged within a space of an air duct.

According to an aspect of the filter device, said electric device is configured to be operated so that different electrical potentials are applied, wherein one electrical potential of said different electrical potentials is configured to be applied to said at least one electrically conductive portion of said electric device and another electrical potential of said different electrical potentials, different from said one electrical potential, is configured to be applied to another at least one electrically conductive portion of said electric device.

According to an aspect of the filter device, said electric device comprises an ionizing unit, arranged, during an ionizing operation, to produce an ionizing volume for charging airborne particles present in the flow of air, wherein the ionizing unit comprises at least one emitter electrode configured to generate ions, and at least one collector electrode, wherein the conductive layer of said filter medium is configured to be electrically connectable, via said conductive filter connection device, to at least one of said at least one collector electrodes, said at least one collector electrode being configured to provide said at least one electrically conductive portion of said electric device. Said at least one emitter electrode is configured to provide at least one other electrically conductive portions.

According to an aspect of the filter device, the electrically conductive material of said filter medium comprises at least two conductive portions separated from each other, wherein the connection device is a first connection device, wherein said filter device comprises a second filter connection device comprising an electrically conductive material, said second filter connection device comprising at least one clamp member, wherein the at least one clamp member of the first filter connection device is configured to be conductively attachable to one of said at least two conductive portions of said filter medium, and the at least one clamp member of the second filter connection device is configured to be conductively attachable to another of said at least two conductive portions of said filter medium, so that, when said at least one clamp member of said first filter connection device is attached to said one conductive portion of said filter medium and said at least one clamp member of said second filter connection device is attached to said another conductive portion of said filter medium, said filter medium, by means of said first filter connection device being allowed to be removably electrically connectable to said at least one electrically conductive portion of said electric device and said second filter connection device being allowed to be removably electrically connectable to said one or more other electrically conductive portions of said electric device so as to, when electrically connected, facilitate said air purification operation.

Specifically, an object of the invention is achieved by an electric device comprising at least one electrically conductive portion for electrical connection to a filter connection device of a filter device as set out herein, for providing an air purification operation. Hereby safe, easy and efficient electrical connection between the electric device and the filter device for air purification operation, and safe, easy and efficient removal of said filter device from said electric device is facilitated.

According to an aspect, said electric device comprises an electric device connector comprising or being operably connectable to said electrically conductive portion of said electric device for facilitating said electrical connection with said at least one clamp member of said filter connection device. Hereby safe, easy and efficient electrical connection between the electric device and the filter device for air purification operation, and safe, easy and efficient removal of said filter device from said electric device is facilitated.

According to an aspect, said electric device connector has resilient properties so as to strive towards said at least one clamp member of said filter connection device when electrically connected to said filter connection device. Hereby electrical connection to said filter device may be easily and efficiently maintained during an air purification operation. According to an aspect of the present disclosure, said electric device connector has resilient properties so as to strive towards said at least one clamp member of said filter device, when said filter device is arranged in connection to said electric device within a space of an air duct.

According to an aspect of the present disclosure, said electric device comprises a power supply device for supplying power so as to facilitate said air purification operation.

According to an aspect of the present disclosure, said electric device comprises an ionizing unit, said ionizing unit being arranged, during an air purification operation, to produce an ionizing volume for charging airborne particles present in the flow of air, the ionizing unit comprising at least one emitter electrode. According to an aspect of the present disclosure, said ionizing unit comprising at least one collector electrode. According to an aspect of the present disclosure, the conductive layer of said filter medium, for an electric device comprising such an ionizing unit, is configured to be connected, via said conductive filter connection device, to at least one of said at least one collector electrodes, which one or more collector electrodes are connected to ground, or to other electrical potential different from the electrical potential of said at least one emitter electrode, so as to, together with said at least one emitter electrode of the ionizing unit, build the required electrical field and corona discharge and hence the ionizing volume for charging airborne particles present in the flow of air. Said at least one collector electrode is configured to provide said at least one electrically conductive portion of said electric device.

According to an aspect of the present disclosure, the electric device, comprising an ionizing device as set out herein, comprises a power supply device configured to provide power, via connections, to the one or more emitter electrodes and one or more collector electrodes, so as to facilitate charge of said one or more emitter electrodes. According to an aspect of the present disclosure, the electric device comprises a first connector arrangement connecting the power supply device to the one or more emitter electrodes, and a second connector arrangement connecting the power supply device to said one or more collector electrodes.

Specifically, an object of the invention is achieved by an air purification device for separating airborne particles from a flow of air in an air duct, the air purification device comprising a filter device as set out herein, and an electric device as set out herein. According to an aspect of the present disclosure, said filter device of said air purification device and at least parts of said electric device of said air purification device are configured, during an air purification operation, to be arranged within a space of an air duct.

According to an aspect of the present disclosure, an object is achieved by an air purification system comprising an air duct and an air purification device as set out herein, said air purification device being configured to be arranged within said air duct during an air purification operation.

### BRIEF DESCRIPTION OF THE DRAWINGS

For a better understanding of the present disclosure reference is made to the following detailed description when read in conjunction with the accompanying drawings, wherein like reference characters refer to like parts throughout the several views, and in which:

FIG. 1 schematically illustrates a perspective view of a filter device according to an aspect of the present disclosure;

FIG. 1a schematically illustrates a perspective view of a portion of the filter device in FIG. 1 with a clamp member of a filter connection device attached to a filter medium of said filter device according to an aspect of the present disclosure;

FIG. 2a schematically illustrates a perspective view of a clamp member according to an aspect of the present disclosure;

FIG. 2b schematically illustrates a perspective view of a clamp member in a non-grip position according to an aspect of the present disclosure;

FIG. 2c schematically illustrates a side view of the clamp member in FIG. 2b according to an aspect of the present disclosure;

FIG. 2d schematically illustrates a perspective view of the clamp member in FIG. 2b in a grip position according to an aspect of the present disclosure;

FIG. 2e schematically illustrates a side view of the clamp member in FIG. 2d according to an aspect of the present disclosure;

FIG. 3 schematically illustrates a perspective view of a filter device and an electric device arranged within an air duct according, said filter device being disconnected from said electric device, according to an aspect of the present disclosure;

FIG. 3a schematically illustrates a perspective view of the filter device in FIG. 3 introduced into the air duct in FIG. 3 and electrically connected to the electric device in said air duct, according to an aspect of the present disclosure;

FIG. 4a schematically illustrates a cross-sectional side view of the filter device in FIG. 3 according to an aspect of the present disclosure;

FIG. 4b schematically illustrates a cross-sectional side view of the electric device arranged within an air duct in FIG. 3 according to an aspect of the present disclosure;

FIG. 4c schematically illustrates a cross-sectional side view of the filter device in FIG. 4a introduced into the air duct in FIG. 4b and electrically connected to the electric device in said air duct, according to an aspect of the present disclosure;

FIG. 5 schematically illustrates a perspective view of a filter device and an electric device arranged within an air duct according, said filter device being disconnected from said electric device, according to an aspect of the present disclosure;

FIG. 5a schematically illustrates a perspective view of the filter device in FIG. 5 introduced into the air duct in FIG. 5 and electrically connected to the electric device in said air duct, according to an aspect of the present disclosure;

FIG. 6a schematically illustrates a cross-sectional side view of the filter device in FIG. 5 according to an aspect of the present disclosure;

FIG. 6b schematically illustrates a cross-sectional side view of the electric device arranged within an air duct in FIG. 5b according to an aspect of the present disclosure;

FIG. 6c schematically illustrates a cross-sectional side view of the filter device in FIG. 6a introduced into the air duct in FIG. 6b and electrically connected to the electric device in said air duct, according to an aspect of the present disclosure;

FIG. 7 schematically illustrates a perspective view of a filter device and an electric device connector of an electric device disconnected from said filter device according to an aspect of the present disclosure;

FIG. 7a schematically illustrates a perspective view of a portion of the filter device in FIG. 7 with a clamp member of a filter connection device attached to a filter medium of said filter device and the electric device connector in FIG. 7 disconnected from said filter device according to an aspect of the present disclosure;

FIG. 7b schematically illustrates a perspective view of the electric device connector in FIG. 7 disconnected from said filter device according to an aspect of the present disclosure;

FIG. 8 schematically illustrates a perspective side of the filter device and electric device connector in FIG. 7 electrically connected to said filter device according to an aspect of the present disclosure;

FIG. 8a schematically illustrates a perspective view of a portion of the filter device in FIG. 8 with the clamp member in FIG. 7a of said filter device electrically connected to said electric device connector according to an aspect of the present disclosure;

FIG. 9a schematically illustrates a cross-sectional side view of a portion of the filter device in FIG. 7 according to an aspect of the present disclosure;

FIG. 9b schematically illustrates a cross-sectional side view of the electric device connector in FIG. 7 according to an aspect of the present disclosure;

FIG. 9c schematically illustrates a cross-sectional side view of the portion of the filter device in FIG. 9a electrically connected to the electric device connector in FIG. 9b, according to an aspect of the present disclosure;

FIG. 10 schematically illustrates a side view of a filter device and an electric device connector of an electric device disconnected from said filter device according to an aspect of the present disclosure;

FIG. 10a schematically illustrates a cross-sectional side view of a portion of the filter device in FIG. 10 with a clamp member of a filter connection device attached to a filter medium of said filter device according to an aspect of the present disclosure;

FIG. 10b schematically illustrates a side view of the electric device connector in FIG. 10 disconnected from said filter device according to an aspect of the present disclosure;

FIG. 11 schematically illustrates a side view of the filter device and electric device connector in FIG. 10 electrically connected to said filter device according to an aspect of the present disclosure;

FIG. 11a schematically illustrates a side view of a portion of the filter device in FIG. 11 with the clamp member in FIG. 10a of said filter device electrically connected to said electric device connector according to an aspect of the present disclosure;

FIG. 12 schematically illustrates a side view of a filter device and an electric device connector of an electric device disconnected from said filter device according to an aspect of the present disclosure;

FIG. 12a schematically illustrates a cross-sectional side view of a portion of the filter device in FIG. 12 with a clamp member of a filter connection device attached to a filter medium of said filter device

FIG. 12b schematically illustrates a side view of the electric device connector in FIG. 12 disconnected from said filter device according to an aspect of the present disclosure;

FIG. 13 schematically illustrates a side view of the filter device and electric device connector in FIG. 12 electrically connected to said filter device according to an aspect of the present disclosure;

FIG. 13a schematically illustrates a side view of a portion of the filter device in FIG. 13 with the clamp member in FIG. 12a of said filter device electrically connected to said electric device connector according to an aspect of the present disclosure;

FIG. 14 schematically illustrates a side view of a filter device according to an aspect of the present disclosure;

FIG. 14a schematically illustrates a side view of a portion of the filter device in FIG. 14 with a clamp member of a filter connection device of said filter device attached to a filter medium of said filter device according to an aspect of the present disclosure;

FIG. 15 schematically illustrates a perspective view of a filter device according to an aspect of the present disclosure;

FIG. 15a schematically illustrates a perspective view of a clamp member according to an aspect of the present disclosure;

FIG. 16a schematically illustrates a plan view of the filter device in FIG. 15 according to an aspect of the present disclosure;

FIG. 16b schematically illustrates a cross-sectional side view of the filter device in FIG. 16a according to an aspect of the present disclosure; and,

FIG. 17 schematically illustrates an air purification device 100 according to an aspect of the present disclosure.

### DETAILED DESCRIPTION

Herein “flow of air” refers to air that passes through the air purification device in use. The flow of air may be actively generated in that it is driven by a fan or other such air displacement means, or it may be passive in that it is generated by way of the air being directed through the filter of the air purification device while a vehicle comprising such an air purification device is being driven. The flow of air may also be driven by an air conditioning system of a vehicle.

Herein the term “filter connection device” refers to a device comprising a conductive material and being attachable to a filter medium such that electrical connection with electrically conductive material of said filter medium is facilitated. Said filter connection device comprises at least one clamp member. said filter connection device may be constituted by a single clamp member. said filter connection device may be constituted by two or more clamp members. Said filter connection device may be constituted by one or more clamp members and one or more additional parts, said additional parts being conductive parts for conductive connection to electrically conductive material of said filter medium and/or attaching parts for facilitating attachment to said filter medium.

Herein the term “clamp member” in relation to said filter connection device comprising at least one clamp member, refers to any member configured to be suitable for conductive attachment to the filter medium comprising an electrically conductive material and electrical connection to an electrically conductive portion of an electric device. According to an aspect of the filter device, said at least one clamp member comprises a conductive contact portion having a contact surface configured to facilitate conductive connection to said electrically conductive portion of said electric device. Said clamp member may be made of a conductive material or have at least conductive parts so as to provide connection with conductive material of the filter medium and facilitate conductive connection with conductive portion/part of an electric device.

According to an aspect of the present disclosure, said at least one clamp member being configured to be conductively attachable to a conductive portion of a filter medium, is configured such that it is attachable to said conductive portion of said filter medium, so that it is non-removably attached, and e.g. not intended to be re-used, should said filter medium be required to be replaced. According to an aspect of the present disclosure, such an at least one clamp member configured to be conductively attachable to a conductive portion of said filter medium, may be said to be configured such that it is permanently attachable to said conductive portion of said filter medium, wherein, should the filter medium be replaced, a new at least one clamp member is configured to be attached to a conductive portion of that filter medium. Such a filter device is according to an aspect, when manufactured, configured to be provided with said at least one clamp member configured to be conductively attachable to a conductive portion of said filter medium, so that the at least one clamp member is attached to said filter device.

According to an aspect of the present disclosure, said at least one clamp member being configured to be conductively attachable to a conductive portion of said filter medium, is configured such that it is removably attachable to said conductive portion of said filter medium, so that, if said filter medium needs to be replaced, said at least one clamp member may be re-used for another filter medium comprising an electrically conductive material, wherein said at least one clamp member is configured to be conductively attachable to a conductive portion of that filter medium. Such an at least one clamp member may according to an aspect be attachable to any suitable filter medium comprising an electrically conductive material, but not initially being provided with any such clamp member.

Herein the term “air flow” and “flow of air” refers to the flow of air that passes through the filter device in use. According to an aspect of the present disclosure, filter device in use refers to when the filter medium of said filter device is electrically connected, via a connection device of the filter device, to an electric device during an air purification operation. The air flow may be actively generated in that it is driven by a fan or other such air displacement means, or it may be passive in that it is generated by way of the air being directed through the filter medium while a vehicle comprising such a filter device is being driven. The air flow may also be driven by the air conditioning system of a vehicle.

According to an aspect of the present disclosure, the term “filter medium” may refer to a filter configuration which comprises a porous structure permeable to gases. According to an aspect of the present disclosure, the term “filter medium” may be used herein to denote a natural or synthetic material or a manufactured article used for filtration which have a porous structure permeable to gases, and which would entrap at least a subset of airborne particles.

Herein the term “filter medium comprising an electrically conductive material” refers to any suitable filter medium having an electrically conductive material to which a filter connection device comprising an electrically conductive material may be conductively attached so that electrical connection of said filter device, by means of said filter connection device, to at least one electrically conductive portion of an electric device is facilitated. There are many ways of achieving a filter medium comprising a conductive material.

According to an aspect of the present disclosure, the conductive material may form an integral part of the filter medium, such as a carbon filter layer or the like. According to an aspect of the present disclosure, the conductive material may also be added as a conductive particle media, e.g. by spraying or by other means providing conductive particles on a surface of within the filter media. A further alternative is to add a mesh of a conductive material, such as a metal mesh, to the filter medium, either on the surface of or in-between layers of the filter media.

The filter medium according to the present disclosure may be provided with layers which may comprise layer configured to adhere particle matters passing through. The layers may further comprise a conductive layer, i.e. a layer of conductive material, e.g. activated carbon. The layers may further comprise an anti-allergen layer configured to protect against air floating allergens. According to an aspect of the present disclosure, the filter medium may comprise more than one conductive layer, e.g. two conductive layers, separated from each other. Herein, more than one conductive layer, e.g. two conductive layers, may refer to layers, e.g. two layers one above the other and not in contact with each other, or layers, e.g. two layers, being on the same level but divided into more than one layer, e.g. two layers.

The conductive material of said filter medium, e.g. conductive portion, e.g. conductive layer, e.g. activated carbon layer, is configured to be connected, via a conductive filter connection device, to ground, or to other electrical potential of an electric device. The conductive layer, e.g. activated carbon layer, is configured to be connected, via a conductive filter connection device, to ground, or to other electrical potential of an electric device.

A conductive layer in the shape of an activated carbon layer may further be designed to protect people, e.g. driver and passengers of a vehicle, from harmful and unpleasant gasses.

According to an aspect of the present disclosure, the term “air purification operation” may be associated with electrically charging particles in the flow of air upstream of the filter medium and/or charging the filter medium comprising said conductive material, and capturing particles/charged particles in the flow of air by means of said filter medium comprising said conductive material.

Herein the wording associated with “electric device configured to be fixedly arranged within or in connection to an air duct” refers to an electric device which is intended to be arranged within or in connection to an air duct and be operably connected for facilitating air purification operation when a filter device is electrically connected to said electric device within said air duct. The filter device is configured to be removably electrically connected to said electric device, when said electric device is thus fixedly arranged. However, according to an aspect of the present disclosure the wording “electric device configured to be fixedly arranged within or in connection to an air duct” does not exclude that the electric device may, if required, be removed from said fixed position, e.g. for repair or maintenance. Such removal is however not associated with removal of the filter device, which is configured to be arranged within said air duct and electrically connected to said electric device such that said filter device may be easily disconnected from said electric device and removed from said air duct with said electric device remaining fixedly arranged within or in connection to said air duct.

According to an aspect of the present disclosure, the electric device is an electric device for a filter medium comprising an electrically conductive material, wherein said electric device may be denoted electric filter device. According to an aspect of the present disclosure, the electric device is an electric device associated with air purification operation by means of a filter device comprising an electrically conductive material. According to an aspect of the present disclosure, the electric device is an electric device configured to be comprised in an air purification device comprising said filter device. According to an aspect of the present disclosure, said electric device is an electric device that is configured to provide electrical connection to a conductive portion of a filter medium in order to facilitate an air purification operation. According to an aspect of the present disclosure, the electric device is an electric device configured to be operated so that different electrical potentials are applied, wherein said different electrical potentials are configured to be applied to different electrically conductive portions of said electric device for facilitating said air purification operation. According to an aspect of the present disclosure, the electric device is an electric device configured to be operated so that at least two different electrical potentials are applied, wherein one of said at least two electrical potentials is configured to be applied to said at least one electrically conductive portion of the electric device to which said filter medium, by means of said filter connection device comprising said clamp member, is electrically connectable to, and another of said at least two electrical potentials is configured to be applied to another electrically conductive portion of the electric device so that said air purification is facilitated. According to an aspect of the present disclosure, said electric device comprises a power supply device for supplying power so as to facilitate providing said at least two electrical potentials. According to an aspect of the present disclosure, said electric device comprises a power supply device for supplying power so as to facilitate said air purification operation. The term “electric device” may also be denoted “electrical device”.

According to an aspect of the present disclosure, the term “electrically conductive portion of an electric device” may refer to any type of electrical portion of an electric device which facilitates being connected to, i.e. provided with, an electrical potential/electrical ground. The term “electrically conductive portion of an electric device” may comprise any suitable electrode member for facilitating provision of electrical potential/electrical ground for air purification operation.

According to an aspect of the present disclosure, the electric device comprises an ionizing unit, arranged, during an ionizing operation, to produce an ionizing volume for charging airborne particles present in the flow of air, wherein the ionizing unit comprises at least one emitter electrode configured to generate ions, and at least one collector electrode. With an electric device comprising such an ionizing unit, the conductive layer, e.g. activated carbon layer, is configured to be connected, via said conductive filter connection device, to at least one of said at least one collector electrodes, which one or more collector electrodes are connected to ground, or to other electrical potential different from the electrical potential of said at least one emitter electrode, so as to, together with said at least one emitter electrode of the ionizing unit, build the required electrical field and corona discharge and hence the ionizing volume for charging airborne particles present in the flow of air. Said at least one collector electrode is hereby configured to provide said at least one electrically conductive portion of said electric device. Further, at least one of said at least one emitter electrode is configured to provide one or more other electrically conductive portions of said electric device. According to an aspect said at least one emitter electrode may be connected to one of said at least two electrical potentials and said at least one collector electrode to another of said at least two electrical potentials, different from the electrical potential to which said at least one emitter electrode is connected. Hereby airborne particles charged in an ionizing volume produced by the air purification device, i.e. the filter device thus electrically connected to said electric device comprising said ionizing unit, will more likely be trapped by the filter medium. The term “ionizing unit” is used herein to denote a combination of an emitter electrode and a collector electrode. The term “emitter electrode” may also be denoted “emitter” or “sender electrode”. The term “collector electrode” may also be denoted “collector”, “receiver electrode” or “receiver”.

According to an aspect of the filter device, said electric device comprises a filter charging unit configured to charge said filter medium of said filter device. Such an electric device comprises said one or more electrical portions to which said filter medium, by means of said filter connection device comprising said clamp member, is electrically connectable to. One of said at least two electrical potentials is configured to be applied to said at least one electrically conductive portion of the electric device to which said filter medium, by means of said filter connection device comprising said clamp member, is electrically connectable to. Said electric device further comprises one or more other electrical portions, wherein another of said at least two electrical potentials is configured to be applied to said one or more other electrically conductive portions such that said filter medium comprising said conductive layer is electrically charged so that air purification operation is facilitated. Such an electric device may be associated with polarization of said filter medium. According to an aspect of the present disclosure, said electric device comprising a filter charging unit may be configured to be comprised in a filter purification device comprising a filter device having a filter medium with an electrically conductive material comprising at least two conductive portions separated from each other, said at least two conductive portions according to an aspect being at least two conductive layers separated from each other. According to an aspect of the present disclosure, said filter device, charged by means of said electric device comprising said filter charging unit, is configured to facilitate capturing charged particles in the flow of air. According to an aspect of the present disclosure, such an electric device may further be configured to charge particles in the flow of air.

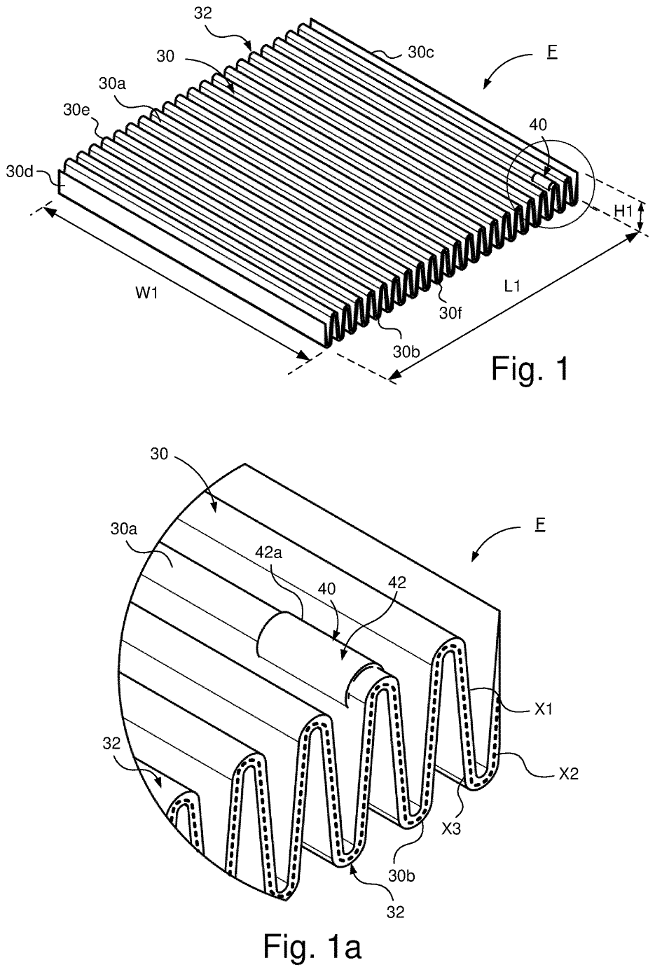

FIG. 1 schematically illustrates a perspective view of a filter device F according to an aspect of the present disclosure; and FIG. 1a schematically illustrates a perspective view of a portion of the filter device F in FIG. 1 with a clamp member 40 of a filter connection device attached to a filter medium 30 of said filter device F according to an aspect of the present disclosure.

Said filter device F thus comprises a filter medium 30. Said filter medium 30 has an inflow side 30a configured, during an air purification operation, to face towards the flow of air A and an opposite outflow side 30b, from which purified air having passed through said filter medium 30 is intended to escape.

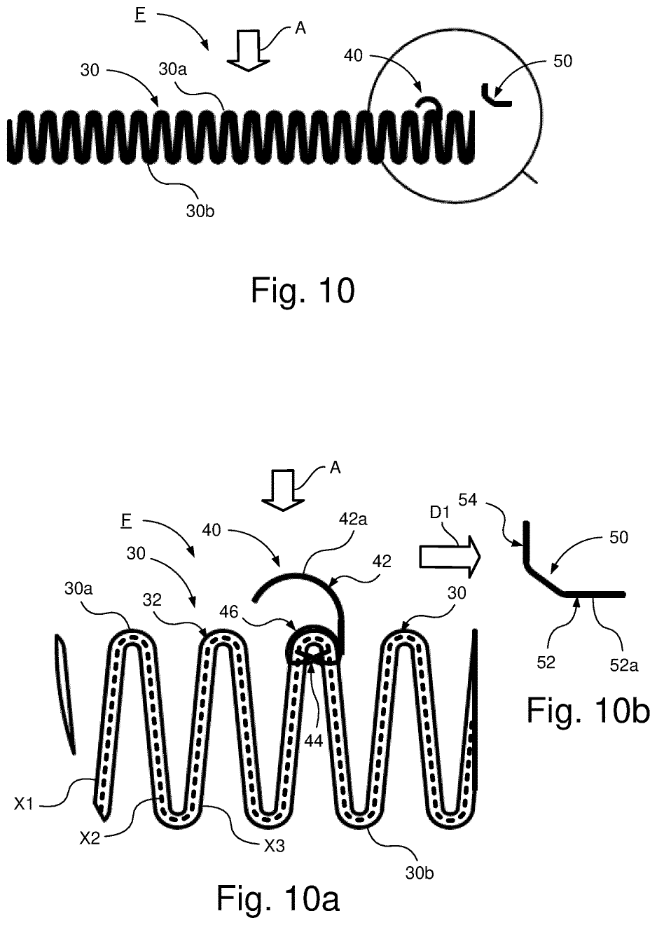

The filter medium 30 according to the present disclosure comprises an electrically conductive material X2, schematically illustrated in FIG. 1a. According to an aspect of the present disclosure, the conductive material may form an integral part of the filter medium 30. According to the embodiment in FIG. 1a, and also FIG. 10a, the conductive material X2 is an electrically conductive layer X2, such as a carbon filter layer or the like.

According to the embodiment in FIG. 1a, and also FIG. 10a, said filter medium 30 comprises a first filter layer X1, and a second layer X2, said second layer X2 being an electrically conductive layer X2 provided by said electrically conductive material X2 of said filter medium 30.

According to the embodiment in FIG. 1a, and also FIG. 10a, said first filter layer X1 is the layer on the inflow side 30a. According to an aspect of the present disclosure, said first filter layer X1 is a particle filter layer configured to provide filtration of particles in the flow of air during an air purification operation. According to the embodiment in FIG. 1a, and also FIG. 10a, said filter medium 30 comprises a third filter layer X3, wherein said second filter layer X2, being an electrically conductive layer X2, is configured to be arranged between said first filter layer X1 and third filter layer X3. According to an aspect of the present disclosure, said electrically conductive layer X2 may be configured to provide at least some particle filtration during an air purification operation. According to an aspect of the present disclosure, said third filter layer X3 may be configured to support said electrically conductive layer X2. According to an aspect of the present disclosure, said third filter layer X3 may be a particle filter layer configured to provide at least some filtration of particles in the flow of air during an air purification operation.

Said filter device F further comprises a filter connection device comprising an electrically conductive material. Said filter connection device comprises at least one clamp member 40 being configured to be conductively attachable to a conductive portion of said filter medium 30. In FIGS. 1 and 1a said filter connection device is provided by a single clamp member 40.

Said clamp member 40 is configured to be conductively attachable to said electrically conductive layer X2.

According to an aspect of the present disclosure, said clamp member 40 is configured to be conductively attachable to said electrically conductive layer X2 via said first filter layer X1. According to an aspect of the present disclosure, said clamp member 40 is configured to be conductively attachable to said electrically conductive layer X2 via said first filter layer X1 and/or said third filter layer X3.

The filter medium 30 of the filter device F has, according to the embodiment illustrated in FIGS. 1 and 1a, a pleated configuration with a set of pleats 32. Thus, said filter medium 30 has a folded configuration providing a bellows. Said set of pleats 32 have a longitudinal extension running essentially parallel to each other.

Said set of pleats 32 has inflow peaks on the inflow side 30a constituting the top end portions on said inflow side 30a, i.e. the end portions configured to be closest to the flow of air and hence first receive flow of air directed towards said inflow side 30a. Said set of pleats 32 has inflow valleys on the inflow side 30a constituting the bottom end portions on said inflow side 30a, i.e. the end portions configured to be furthest away from the flow of air and hence last receive flow of air directed towards said inflow side 30a.

Said set of pleats 32 has outflow peaks on the outflow side 30a constituting the top end portions on said outflow side 30b, constituting the opposite side of said outflow valleys on the inflow side 30a. Said set of pleats 32 has outflow valleys on the outflow side 30b constituting the opposite side of said inflow peaks on said inflow side 30a.

According to an aspect of the present disclosure, the filter medium 30 has a certain length L1, a certain width W1 and a certain height H1. According to an aspect the height H1 corresponds to the distance between the inflow side 30a and outflow side 30b. According to an aspect the height H1 of the filter medium in FIGS. 1 and 1a corresponds to the closest distance between inflow peaks on said inflow side and outflow peaks on said outflow side 30b. According to an aspect of the present disclosure, said width W1 and length L1 has a main extension essentially orthogonal to the height H1. Thus, according to an aspect of the present disclosure said filter medium 30 of said filter device F has an essentially plane main extension.

According to an aspect of the present disclosure, the filter medium 30 has an essentially rectangular configuration with a surrounding edge providing opposite end sides 30c, 30d on long sides of opposite end pleats 32 and opposite end sides 30e, 30f at opposite short sides of the set of pleats 32.

Said clamp member 40 of the filter device F, according to the embodiment illustrated in FIGS. 1 and 1a, is attached to a pleat 32 of said set of pleats 32 of said filter medium 30 such that said clamp member 40 is conductively connected to said electrically conductive material of said filter medium 30. Said clamp member 40 of the filter device F is, according to the embodiment illustrated in FIGS. 1 and 1a, attached to a pleat 32 of said set of pleats 32 of said filter medium 30 on the inflow side 30a of said filter medium 30. Said clamp member 40 of the filter device F is, according to the embodiment illustrated in FIGS. 1 and 1a, attached to an inflow peak of a pleat 32 of said set of pleats 32 of said filter medium 30 on the inflow side 30a of said filter medium 30.

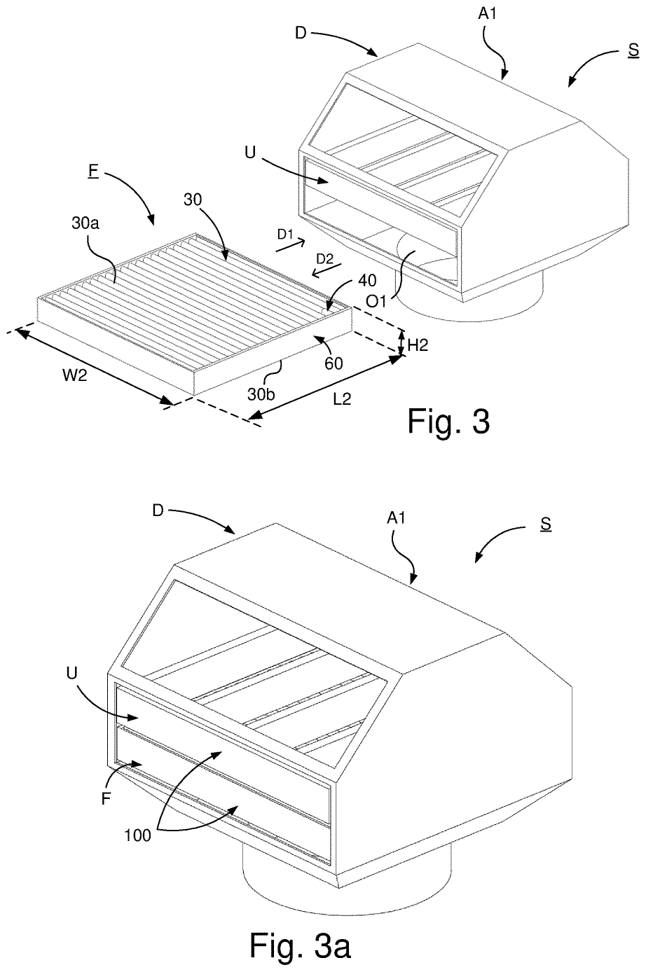

Said filter device F is configured such that, when said clamp member 40 is attached to said filter medium 30, said filter medium 30, by means of said filter clamp member 40, constituting or being comprised in said filter connection device, is allowed to be removably electrically connectable to at least one electrically conductive portion of an electric device, not shown in FIG. 1 or 1a, see e.g. FIGS. 3 and 3a, so as to, when electrically connected, facilitate an air purification operation.

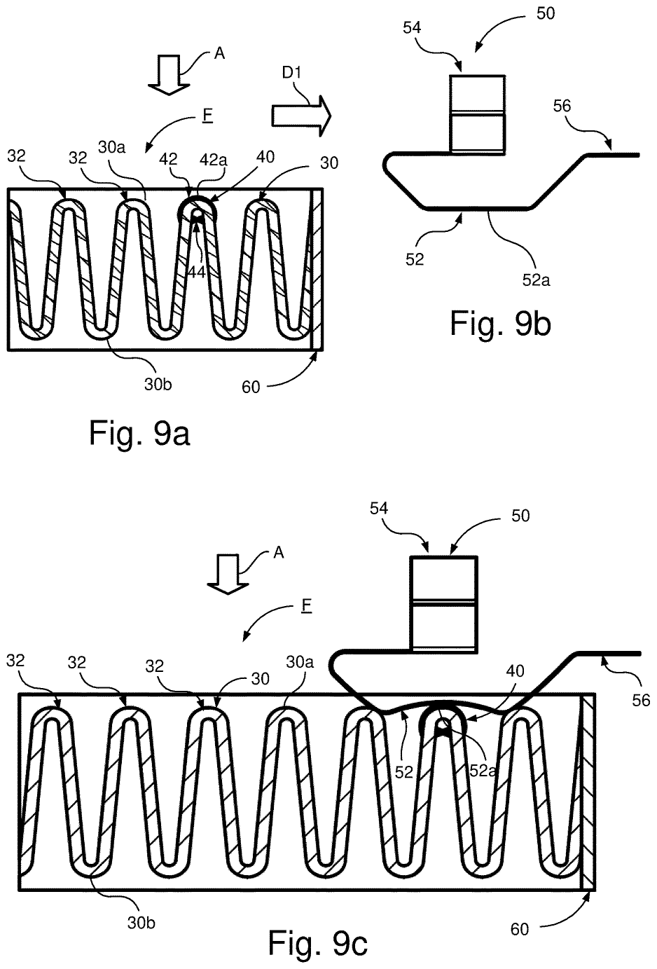

According to an aspect of the present disclosure, illustrated e.g. in FIG. 1a, said at least one clamp member 40 comprises a conductive contact portion 42 having a contact surface 42a configured to facilitate conductive connection to said electrically conductive portion of an electric device, see e.g. FIG. 9c.

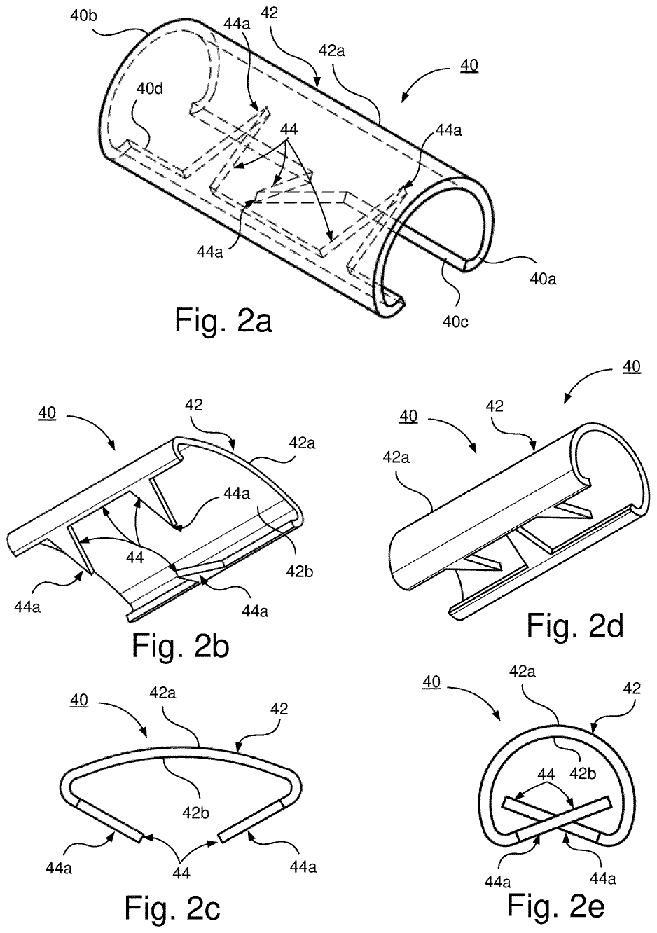

According to an aspect of the present disclosure, said at least one clamp member 40 comprises a grip portion 44 configured to facilitate attachment and conductive connection of said at least one clamp member 40 to said filter medium 30. FIGS. 2a-e schematically illustrates different views of a clamp member 40 with a grip portion 44.

The clamp member in FIGS. 2a-e may, according to an aspect, correspond to the clamp member 40 in FIGS. 1 and 1a. The clamp member 40 comprises a conductive contact portion 42 having a contact surface 42a configured to facilitate conductive connection to said electrically conductive portion of an electric device. The conductive contact portion 42 of the clamp member 40 has an attachment side 42b configured, when said clamp member is attached to said filter medium 30, to face said filter medium 30, e.g. a peak of a pleat of a filter medium 30 having a pleated configuration. Said attachment side 42b is opposite to said a contact surface 42a.

According to an aspect of the present disclosure, as illustrated in FIGS. 2a-e, said clamp member 40 has a longitudinal extension with opposite end sides 40a, 40b, see FIG. 2a. According to an aspect of the present disclosure, as illustrated in FIGS. 2a-e, said clamp member 40 has an arc-shaped configuration. According to an aspect of the present disclosure, as illustrated in FIGS. 2b and 2d, said clamp member 40 has a pipe configuration, in a grip position of the clamp member 40, configured to facilitate gripping about a peak of a pleat of a filter medium having a pleated configuration. Said pipe configuration of said clamp member 40 is configured such that there is an opening essentially opposite to said contact portion 42, running in the longitudinal extension of said clamp member 40. Said longitudinally running opening is provided by opposite edges 40c, 40d of said clamp member 40.

According to an aspect of the present disclosure, said grip portion 44 of said at least one clamp member 40 comprises one or more conductive pins 44a configured to provide conductive connection to conductive parts of said filter medium 30 when attached to the filter medium 30. In the embodiment illustrated in FIGS. 2a-e, said grip portion 44 comprises a set of pins 44a, here three pins 44a. According to an aspect of the present disclosure, said conductive pins 44a are configured to protrude from said opposite edges 40c, 40d of said clamp member 40 so as to provide efficient conductive connection to conductive part of said filter medium, when said clamp member 40 is attached to said filter medium.

According to an aspect of the present disclosure, said grip portion 44 of said at least one clamp member 40 comprises one or more retention members configured to facilitate retention of said at least one clamp member 40 when said clamp member 40 is attached to said filter medium 30.

According to an aspect of the present disclosure, said conductive pins 44a constitute or comprise said retention members. According to an aspect of the present disclosure, said conductive pins 44a comprises retention members, where said retention members of said one or more conductive pins according to an aspect are constituted by one or more barbs, not shown, on one or more of said one or more pins 44a.

FIG. 2a schematically illustrates a perspective view of a clamp member 40 according to an aspect of the present disclosure, where the clamp member 40 is in a grip position. FIG. 2b schematically illustrates a perspective view and FIG. 2c a side view of a clamp member 40 in a non-grip position according to an aspect of the present disclosure. FIG. 2d schematically illustrates a perspective view and FIG. 2e a side view of the clamp member 40 in FIG. 2b in a grip position according to an aspect of the present disclosure.

According to an aspect of the present disclosure, said clamp member 40 is operable between a non-grip position and a grip position so as to facilitate attachment to said filter medium 30. Thus, said grip portion 44 of said clamp member 40 is configured to be operable between a non-grip position and a grip position so as to facilitate attachment to said filter medium 30.

According to an aspect of the present disclosure, said clamp member 40 has resilient properties so as to facilitate attachment to said filter medium 30 and, where applicable, removal from said filter medium 30. According to an aspect of the present disclosure, said resilient properties of said clamp member 40 provides a resilient function such that said grip portion 44 comprising said conductive pins 44a is configured to strive towards said filter medium, e.g. pleat of said filter medium, when said clamp member 40 is attached to said filter medium. Thus, according to an aspect of the present disclosure, said clamp member 40 is elastically deformable. According to an aspect of the present disclosure, said clamp member 40 is elastically deformable such that said grip portion 44 of said clamp member 40, in connection to an attachment operation for attaching said clamp member to a filter medium, by means of a certain force extending the width of the opening essentially opposite to said contact portion 42, is movable from said grip position to said non-grip position prior to said attachment, wherein said clamp member is applied in connection to said filter medium, and wherein, when said force holding said clamp member 40 in the non-grip position is released, said grip portion 44 of said clamp member 40 is configured to return to the grip position, providing said attachment to said filter medium.

According to another aspect of the present disclosure, said clamp member 40 is plastically deformable such that said grip portion 44 of said clamp member 40, in connection to an attachment operation for attaching said clamp member to a filter medium, initially is in the non-grip position. In connection to said attachment operation for attaching said clamp member to a filter medium, said clamp member 40 is applied in connection to said filter medium, wherein a certain force narrowing the width of the opening essentially opposite to said contact portion 42 is applied so that said clamp member is subjected to a plastic deformation such that said grip portion 44 is moved to the grip position, providing said attachment to said filter medium. Said grip portion 44 of said clamp member 40 is then, due to the plastic deformation, configured to remain in the grip position when attached to the filter medium. According to an aspect of the present disclosure, said clamp member 40, by means of applying a force exceeding a certain threshold value so that said grip portion 44 is returned to the non-grip position, may be removed from said filter medium.

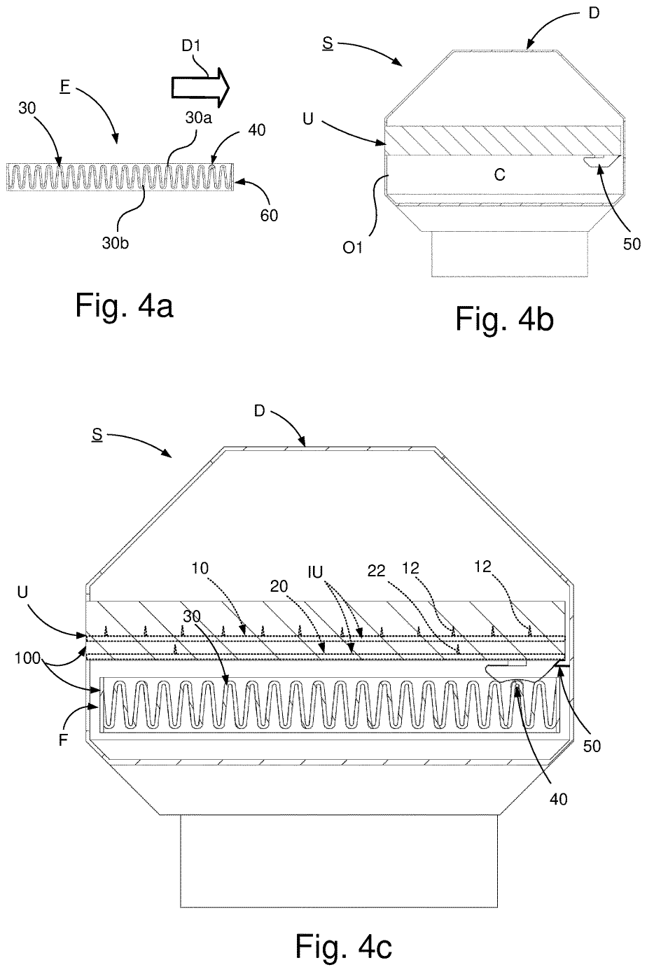

FIG. 3 schematically illustrates a perspective view of a filter device F and an electric device U arranged within an air duct D, said filter device F being disconnected from said electric device U, according to an aspect of the present disclosure. FIG. 4a schematically illustrates a cross-sectional side view of a filter device F according to an aspect of the present disclosure.

According to the embodiment illustrated in FIGS. 3 and 4a, said filter device F comprises a filter medium 30 essentially corresponding to the filter medium 30 illustrated in FIGS. 1 and 1a. According to the embodiment illustrated in FIGS. 3 and 4a, said filter device F comprises a clamp member 40 essentially corresponding to the clamp member 40 illustrated in FIGS. 1 and 1a.

According to the embodiment illustrated in FIGS. 3 and 4a, said filter device F comprises an edge member 60 configured to at least partly surround said filter medium 30. According to the embodiment illustrated in FIGS. 3 and 4a, said edge member 60 is configured to be arranged at the edge, i.e. end sides, of said filter medium 30. According to the embodiment illustrated in FIGS. 3 and 4a, said edge member 60 has a frame configuration.

According to an aspect of the present disclosure, said frame shaped edge member 60 of said filter device F has a certain length L2, a certain width W2 and a certain height H2. According to an aspect of the present disclosure, said frame shaped edge member 60 of said filter device F is configured to support and hold said filter medium 30 together. According to an aspect of the present disclosure, said frame shaped edge member 60 of said filter device F is configured to house said filter medium 30. According to an aspect of the present disclosure, said filter medium 30 is configured to be closely received within said frame shaped edge member 60. According to an aspect of the present disclosure, said width W2 and length L2 of the edge member 60 has a main extension essentially orthogonal to the height H2. Thus, according to an aspect of the present disclosure said filter device F has an essentially plane main extension.

FIG. 4b schematically illustrates a cross-sectional side view of the electric device U arranged within said air duct D illustrated in FIG. 3 according to an aspect of the present disclosure. Said electric device U is according to an aspect of the present disclosure configured to be fixedly arranged within said air duct D. Said air duct D comprises an air inlet A1 for introducing air configured to be purified. Said air duct D comprises an opening O1 and an inner compartment C for receiving said filter device F. Said opening O1 and inner compartment C for said filter device F is arranged downstream of said electric device U arranged within said air duct D. The shape of said filter device F is adapted to said opening O1 and compartment C.

Said electric device U comprises an electric device connector 50 comprising or being operably connectable to said electrically conductive portion of said electric device U for facilitating said electrical connection with said clamp member 40 of said filter device F.

Said electric device U may be any suitable electric device. According to an aspect of the present disclosure, the electric device U is an electric device configured to be operated so that different electrical potentials are applied, wherein said different electrical potentials are configured to be applied to different electrically conductive portions of said electric device U for facilitating said air purification operation. According to an aspect of the present disclosure, the electric device U is an electric device U configured to be operated so that at least two different electrical potentials are applied, wherein one of said at least two electrical potentials is configured to be applied to said at least one electrically conductive portion of the electric device U to which said filter medium 30, by means of said filter connection device comprising said clamp member 40, is electrically connectable to, and another of said at least two electrical potentials is configured to be applied to another electrically conductive portion of the electric device U so that said air purification is facilitated. According to an aspect of the present disclosure, said electric device U comprises a power supply device for supplying power so as to facilitate providing said at least two electrical potentials.

According to an aspect of the present disclosure, the electric device U comprises an ionizing unit, arranged, during an ionizing operation, to produce an ionizing volume for charging airborne particles present in the flow of air, wherein the ionizing unit comprises at least one emitter electrode configured to generate ions, and at least one collector electrode. With an electric device U comprising such an ionizing unit, the electrically conductive material of said filter medium 30 is configured to be connected, via said clamp member 40, to a collector electrode which is configured to be connected to ground, or to other electrical potential different from the electrical potential of the at least one emitter electrode, so as to, together with said at least one emitter electrode of the ionizing unit, build the required electrical field and corona discharge and hence the ionizing volume for charging airborne particles present in the flow of air.

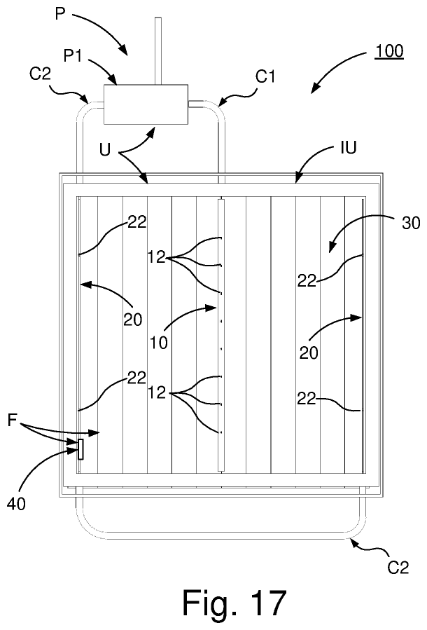

FIG. 17 schematically illustrates an air purification device 100 according to an aspect of the present disclosure.

The air purification device 100 comprises a filter device F. Said filter device F may be any suitable filter device, e.g. a filter device F according to FIG. 1. Said filter device F thus comprises a filter medium 30 with a conductive layer, for example carbon layer. Said filter device F further comprises a filter connection device comprising an electrically conductive material. Said filter connection device comprises at least one clamp member 40 being configured to be conductively attachable to a conductive portion of said filter medium 30.

The air purification device 100 comprises an electric device U. Said electric device U comprises an ionizing unit IU. Said ionizing unit IU is, according to an aspect of the present disclosure, during an ionizing operation, configured to produce an ionizing volume for charging airborne particles present in the flow of air.

The ionizing unit IU comprises an emitter electrode 10. According to this example, said emitter electrode 10 comprises a plurality of emitter discharge protrusions 12. Said emitter electrode 10 has according to the embodiment schematically illustrated in FIG. 17 an elongated configuration, provided as an elongated member such as a bar or the like. Said plurality of emitter discharge protrusions 12 are, according to the embodiment schematically illustrated in FIG. 17, configured to be distributed along said elongated emitter electrode 10. Said plurality of emitter discharge protrusions 12 are, according to the embodiment schematically illustrated in FIG. 17, configured to point away from said filter medium 30. Said emitter electrode 10 is configured to be charged for generating ions.

The ionizing unit IU further comprises collector electrodes 20, here a pair of collector electrodes 20. The respective collector electrode 20 comprises discharge protrusions 22, here a pair of discharge protrusions 22. The respective collector electrode 20 has according to the embodiment schematically illustrated in FIG. 17 an elongated configuration, provided as an elongated member such as a bar or the like.

According to the schematic example illustrated in FIG. 17 the one of said elongated collector electrodes 20 is arranged at one side at a distance from said elongated emitter electrode 10 and configured to run essentially parallel to said elongated emitter electrode 10, and the other of said elongated collector electrodes 20 is arranged at the opposite side at a distance from said elongated emitter electrode 10 and configured to run essentially parallel to said elongated emitter electrode 10.

The conductive layer, e.g. activated carbon layer, of the filter medium 30 is configured to be connected, via said conductive filter connection device comprising said clamp member 40, to one of said collector electrodes 20, said collector electrodes being connected to ground, or to other electrical potential different from the electrical potential of said emitter electrode 10, so as to, together with said emitter electrode 10, build the required electrical field and corona discharge and hence the ionizing volume for charging airborne particles present in the flow of air. Said collector electrode 20 is hereby configured to provide an electrically conductive portion of said electric device U, to which said filter medium 30, by means of said filter connection device is allowed to be removably electrically connectable.

The electric device U of the air purification device 100 comprises a power supply device P configured to provide power, via connections C1, C2 to the emitter electrode 10 and collector electrode 20, so as to facilitate charge of said emitter electrode 10.

According to the schematic example illustrated in FIG. 17, the electric device U of the air purification device 100 comprises a first connector arrangement C1 connecting the power supply device P to the emitter electrode 10, and a second connector arrangement C2 connecting the power supply device P to said collector electrodes 20. According to an aspect of the present disclosure, said power supply device P comprises a power operation unit P1.

Said emitter electrode 10 may be connected to a negative voltage and said collector electrodes 20 to ground or a positive voltage, or, alternatively, said emitter electrode 10 may be connected to a positive voltage and said collector electrodes 10 to ground or a negative voltage. According to a preferred embodiment, the emitter electrode 10 is connected to a negative high voltage and the collector electrode 20 is connected to ground.

The power supply P in FIG. 17 is schematically illustrated an may be configured in any suitable way in order to facilitate arranging said electric device U within an air duct, e.g. an air duct as illustrated in FIG. 3.

The ionizing unit IU schematically illustrated in FIG. 17 is only an example. An electric device having an ionizing unit may be provided with any suitable type of ionizing unit.

FIG. 3a schematically illustrates a perspective view and FIG. 4c a cross-sectional side view of the filter device F in FIGS. 3 and 4a introduced into the air duct D in FIGS. 3 and 4b and electrically connected to the electric device U in said air duct, according to an aspect of the present disclosure. Said filter device F electrically connected to said electric device U is configured to provide an air purification device 100 for facilitating an air purification operation for purification of air. Said air purification device 100 arranged within said air duct D is configured to provide an air purification system S for facilitating an air purification operation for purification of air.

According to an aspect, said filter device F is configured to be removably introduced via said opening O1 into said compartment C of said air duct D. Said at least one clamp member 40 is configured to be attached to said filter medium 30 so that said clamp member 40 of said filter connection device aligns with and electrically connects to said electric device connector 50 of said electric device U being fixedly arranged within said air duct.

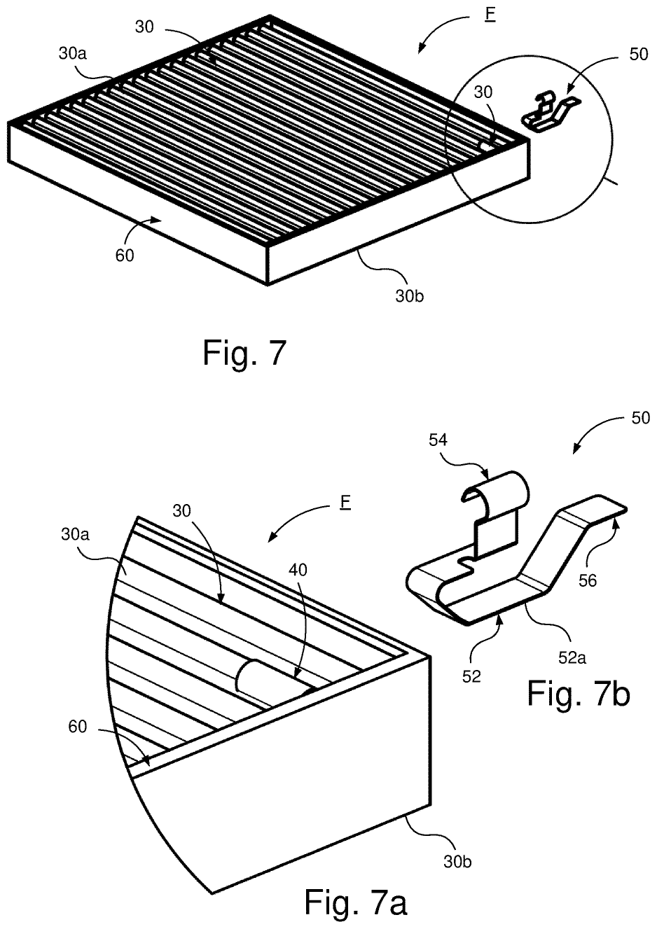

According to an aspect, said filter device F has an essentially plane main extension, wherein said at least one clamp member 40 is configured to be attached to said filter medium 30 so that said filter device F may be introduced, by moving the filter device F in the direction D1 of its main extension, towards and into said compartment C of said air duct via said opening O1, downstream of said electric device U arranged within said compartment C for facilitating said electrical connection to said electric device connector 50 of said electric device U. According to an aspect of the present disclosure, said electric device connector 50 has resilient properties so as to strive towards said clamp member 40 of said filter connection device when electrically connected to said clamp member 40, see e.g. 4c. Such an electric device connector 50 is illustrated in e.g. FIG. 7b. Such an electric device connector 50 may be configured to be connected to a bar-shaped collector electrode of an electric device U comprising an ionizing unit.

Further, when said filter device F is arranged within said compartment C in electrical connection, via said clamp member 40, to said at least one electrically conductive portion of said electric device U, said filter device F may be removed from said compartment C by moving said filter device F in the direction D2 of its main extension out from said compartment C via said opening O1 so that said at least one clamp member 40 of said filter device F is disconnected from said at least one electrically conductive portion of said electric device U.

In e.g. FIG. 4a said filter device F is moved in the direction of its main extension D1 towards said, in FIG. 4b illustrated opening O1 of said air duct D for electrical connection of the clamp member 40 with the electric device connector 50 of the electric device U.

In FIG. 4c, the electric deviceU has in dotted line been illustrated as comprising an ionizing unit IU comprising an emitter electrode 10 with emitter discharge protrusions 12 and a collector electrode 20, here with discharge protrusions 22, wherein the conductive layer of the filter medium 30, via said conductive filter connection device comprising said clamp member 40 is configured to be electrically connected to the collector electrode, providing an electrically conductive portion of the electric device U. The electric device U may be any suitable electric device. When the electric device U, as exemplified in FIG. 4c, comprises an ionizing unit, the ionizing unit may be any type of ionizing unit, e.g. ionizing unit without discharge protrusions.

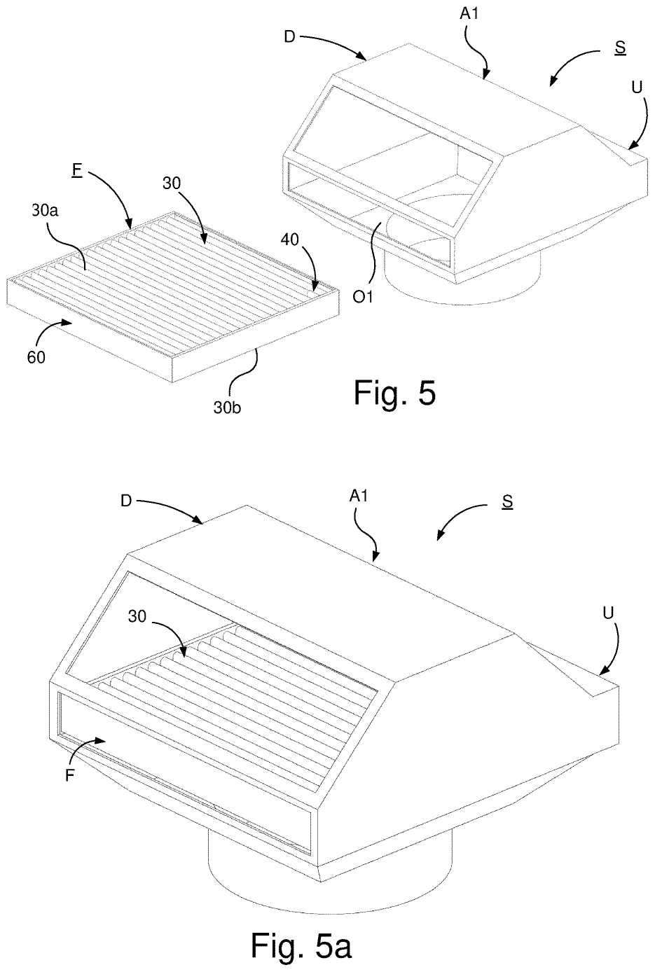

FIG. 5 schematically illustrates a perspective view of a filter device F, and an electric device U arranged within an air duct according to an aspect of the present disclosure. Said filter device F is disconnected from said electric device and not introduced into said air duct D.

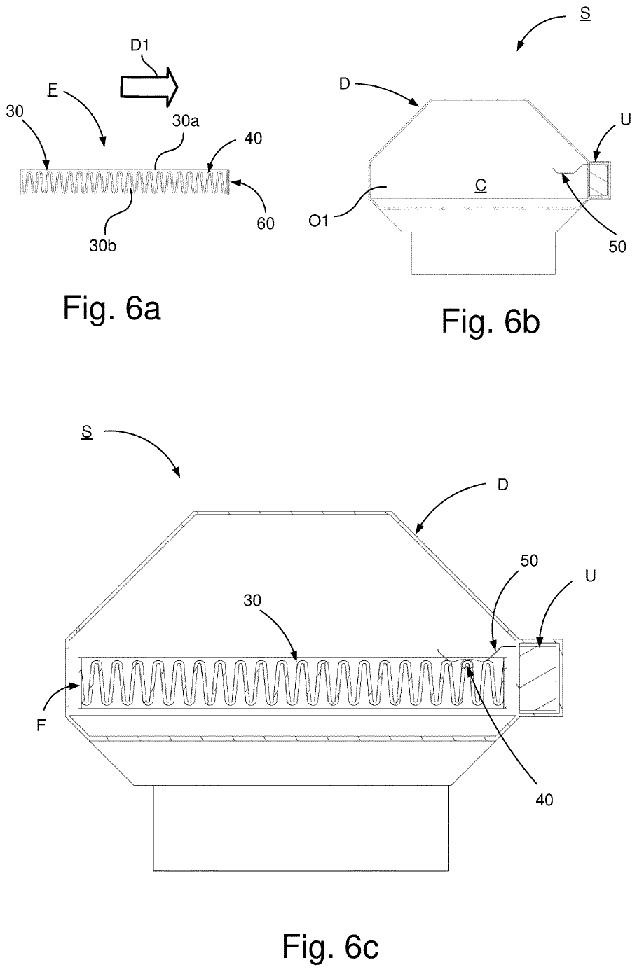

FIG. 6a schematically illustrates a cross-sectional side view of the filter device F in FIG. 5. The filter device F in FIGS. 5 and 6a essentially corresponds to the filter device F in FIGS. 3 and 4a.

FIG. 6b schematically illustrates a cross-sectional side view of the electric device U arranged within an air duct D in FIG. 5. The electric device U in FIGS. 5 and 6b differs from the electric device in FIGS. 3 and 4b by its shape and location within said air duct D. The electric device U in FIGS. 5 and 6b is configured to be fixedly arranged in a space within said air duct D providing an extension of the compartment C for housing said filter device F. Said electric device U in FIGS. 5 and 6b is configured to be fixedly arranged at essentially the same level as the filter device F, when said filter device F is arranged within said compartment C. Said electric device U in FIGS. 5 and 6b is configured to be fixedly arranged in connection to an end side of said filter device F furthers away from said opening O1, when said filter device F is arranged within said compartment C. Said air duct in FIGS. 5 and 6b differs from the air duct in FIGS. 3 and 4b-c in that there is an additional space for housing said electric device U.

FIG. 5a schematically illustrates a perspective view and FIG. 6c a cross-sectional side view of the filter device F in FIGS. 5 and 6a introduced into the air duct D in FIGS. 5 and 6b and electrically connected to an electric device connector 50 of the electric device U in said air duct, according to an aspect of the present disclosure.

In e.g. FIG. 6a said filter device F is moved in the direction of its main extension D1 towards said, in FIG. 6b illustrated opening O1 of said air duct D for electrical connection of the clamp member 40 with the electric device connector 50 of the electric device U.

FIG. 7 schematically illustrates a perspective view of a filter device F and an electric device connector 50 of an electric device, not shown, disconnected from said filter device F according to an aspect of the present disclosure; and FIG. 7a schematically illustrates a perspective view of a portion of the filter device in FIG. 7 with a clamp member 40 of a filter connection device attached to a filter medium 30 of said filter device F according to an aspect of the present disclosure. FIG. 9a schematically illustrates a cross-sectional side view of a portion of the filter device F in FIG. 7 according to an aspect of the present disclosure. FIG. 7b schematically illustrates a perspective view and FIG. 9b a cross-sectional side view of the electric device connector 50 in FIG. 7 according to an aspect of the present disclosure.

The filter device F in FIGS. 7, 7a and 9a essentially corresponds to the filter device illustrated in FIGS. 3a and 4a.

Said electric device connector 50 is according to an aspect of the present disclosure configured to be an integrated portion of said electric device for facilitating said electrical connection with said clamp member 40 of said filter device F. Said electric device connector 50 is according to an aspect of the present disclosure configured to be operably connectable to an electrically conductive portion of said electric device for facilitating said electrical connection with said clamp member 40 of said filter device.

According to an aspect of the present disclosure, said electric device connector 50 has resilient properties so as to strive towards said clamp member 40 when electrically connected to said filter connection device comprising said clamp member 40. According to an aspect of the present disclosure, said electric device connector 50 has resilient properties so as to strive towards said clamp member 40 of said filter device F, when said filter device F is arranged in connection to said electric device within a space of an air duct.

According to an aspect of the present disclosure, said electric device connector 50 comprises a conductive contact portion 52 having a contact surface 52a configured to facilitate conductive connection to said clamp member 40 of said filter device F. According to an aspect of the present disclosure, said electric device connector 50 comprises a conductive contact portion 52 having a contact surface 52a configured to facilitate conductive connection to said contact surface 42a of said conductive portion 42 of said clamp member 40 of said filter device F. Said conductive contact portion 52 has a blade configuration having resilient properties so as to strive towards said clamp member 40 when electrically connected to said clamp member 40. Said conductive contact portion 52 has an elongated extension configured, when electrically connected said clamp member 40, to run transversal relative to the longitudinal extension of said clamp member 40.

According to an aspect of the present disclosure, said electric device connector 50 comprises a conductive connection portion 54 configured to facilitate conductive connection to an electric portion of said electric device so as to facilitate air purification operation. Said conductive connection portion 54 may be configured to be connected to a bar-shaped collector electrode of an electric device U comprising an ionizing unit. Said conductive connection portion 54, when said conductive contact portion 52 of said electric device connector 50 is conductively connected to said conductive portion 42 of said clamp member 40, is configured to protrude in a direction away from said inflow side 30a of said filter medium 30.

According to an aspect of the present disclosure, said electric device connector 50 comprises an attachment portion 56 configured facilitate attachment of electric device connector 50 to a portion of said electric device. Said attachment portion 56 is, according to an aspect, an extension of said conductive contact portion 52, configured to run with an angle relative to said conductive contact portion 52 so as to facilitate said resilient properties of said electric device connector 50. Said attachment portion 56, when said electric device connector is connected to said clamp member 40 on said filter medium 30, is configured to run from said conductive contact portion 52 with an angle away from said inflow side 30a of said filter medium 30. Said attachment portion 56 is, according to an aspect, has a blade configuration.

According to an aspect of the present disclosure, said electric device connector 50 has a blade-like configuration with conductive properties. According to an aspect of the present disclosure, said attachment portion 56 of said blade-like electric device connector 50 transfers into said conductive contact portion 52 which in turn transfers into said conductive connection portion 54 by turning, when connected to said clamp member 40 on said inflow side 30a of said filter medium 30, upwardly away from said inflow side and then back above said conductive contact portion 52 and then upwardly further away from said inflow side 30a with an end portion of said conductive connection portion 54.

In e.g. FIG. 9a said filter device F is moved in the direction of its main extension D1 towards said, in FIG. 9b illustrated, electric device connector 50 of said electric device, not shown.

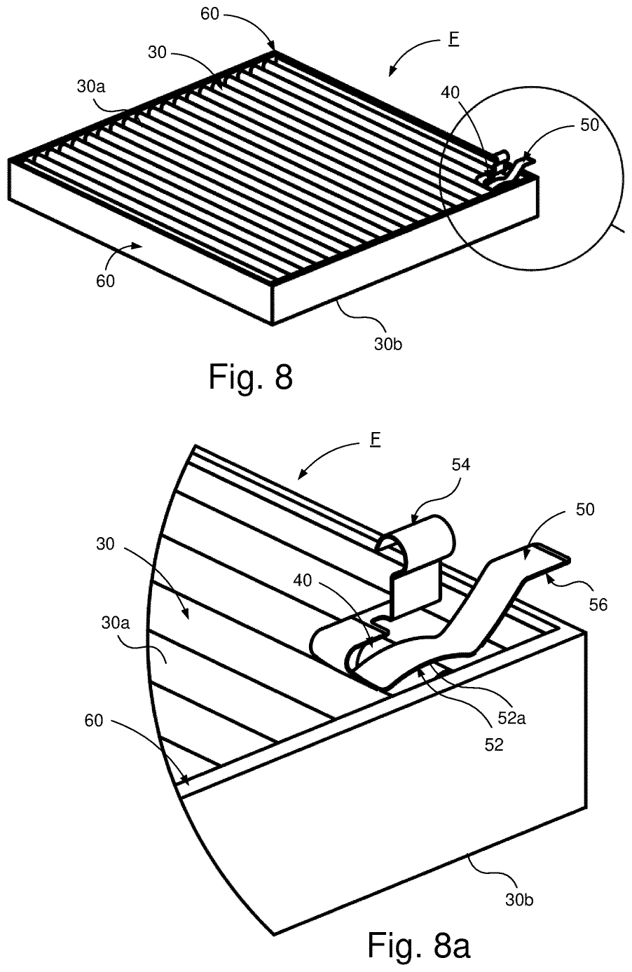

FIG. 8 schematically illustrates a perspective view of the filter device F and electric device connector 50 in FIG. 7 electrically connected to said filter device according to an aspect of the present disclosure; FIG. 8a schematically illustrates a perspective view and FIG. 9c a cross-sectional side view of a portion of the filter device F in FIG. 8 with the clamp member 40 in FIG. 7a of said filter device electrically connected to said electric device connector 50 according to an aspect of the present disclosure.

FIG. 10 schematically illustrates a side view of a filter device F and an electric device connector 50 of an electric device, not shown, disconnected from said filter device F according to an aspect of the present disclosure; and FIG. 10a schematically illustrates a cross-sectional side view of a portion of the filter device in FIG. 10 with a clamp member 40 of a filter connection device attached to a filter medium 30 of said filter device F according to an aspect of the present disclosure. FIG. 10b schematically illustrates a cross-sectional side view of the electric device connector 50 in FIG. 10 according to an aspect of the present disclosure.

The filter medium 30 of the filter device F in FIGS. 10 and 10a essentially corresponds to the filter medium illustrated in FIGS. 1 and 1a.

Said electric device connector 50 is according to an aspect of the present disclosure configured to be an integrated portion of said electric device for facilitating said electrical connection with said clamp member 40 of said filter device F. Said electric device connector 50 is according to an alternative aspect of the present disclosure configured to be operably connectable to an electrically conductive portion of said electric device for facilitating said electrical connection with said clamp member 40 of said filter device.

According to an aspect of the present disclosure, said clamp member 40 has resilient properties so as to strive towards said electric device connector 50 of said electric device, when arranged in connection to said electric device. According to an aspect of the present disclosure, said clamp member 40 has resilient properties so as to strive towards said electric device connector 50, when said filter device F is arranged in connection to said electric device within a space of an air duct.

According to an aspect of the present disclosure, said clamp member 40 comprises a conductive contact portion 42 having a contact surface 42a configured to facilitate conductive connection to said electric device connector 50 of said electric device. According to an aspect of the present disclosure, said clamp member 40 comprises a conductive contact portion 42 has resilient properties so as to strive towards said electric device connector 50 of said electric device, when arranged in connection to said electric device.

According to an aspect of the present disclosure, said clamp member 40 comprises a grip portion 44 configured to facilitate attachment and conductive connection of said clamp member 40 to said filter medium 30. The grip portion 44 of said clamp member 40 in FIGS. 10, 10a may, according to an aspect, essentially correspond to the grip member of the clamp member in FIGS. 2a, 2d-e. The clamp member 40 in FIGS. 10, 10a differs from the clamp member in FIGS. 2a, 2d-e by having said resilient properties so as to strive towards said electric device connector 50. The clamp member 40 in FIGS. 10, 10a differs from the clamp member in FIGS. 2a, 2d-e in that the conductive contact portion 42 has said resilient properties so as to strive towards said electric device connector 50.

According to an aspect of the present disclosure, said clamp member 40 comprises an attachment portion 46 configured to be arranged in connection to said filter medium 30, here in connection to an inflow peak of a pleat 32 of said filter medium 30. According to an aspect of the present disclosure, said attachment portion 46, from a shape point of view, essentially corresponds to the conductive contact portion of the clamp member in FIGS. 2a, 2d-e. Said attachment portion 46, according to an aspect, is configured to transfer into said grip portion 44. Said grip portion 44 is according to an aspect configured to be conductively connected to conductive part(s) X2, here conductive layer X2, of said filter medium 30, e.g. via pins, see e.g. FIG. 10a.

According to an aspect of the present disclosure, said conductive contact portion 42 is attached to said attachment portion 46 so as to facilitate said resilient properties of said conductive contact portion 42 so as to strive towards said electric device connector 50 of said electric device, when arranged in connection to said electric device. According to an aspect, said conductive contact portion 42 is attached to said attachment portion 46 so that, when said conductive contact portion 42 of said clamp member is attached to said filter medium 30, said conductive contact portion 42 is configured to protrude in a direction away from said inflow side 30a of said filter medium 30, and away from said attachment portion 46.

According to an aspect of the present disclosure, said electric device connector 50 comprises a conductive contact portion 52 having a contact surface 52a configured to facilitate conductive connection to said clamp member 40 of said filter device F. According to an aspect of the present disclosure, said electric device connector 50 comprises a conductive contact portion 52 having a contact surface 52a configured to facilitate conductive connection to said contact surface 42a of said conductive portion 42 of said clamp member 40 of said filter device F.

According to an aspect of the present disclosure, said electric device connector 50 comprises an attachment portion 54 for facilitating attachment of the electric device connector 50 to the electric device, not shown.

In FIG. 10a said filter device F is moved in the direction of its main extension D1 towards said, in FIG. 10b illustrated, electric device connector 50 of said electric device, not shown.

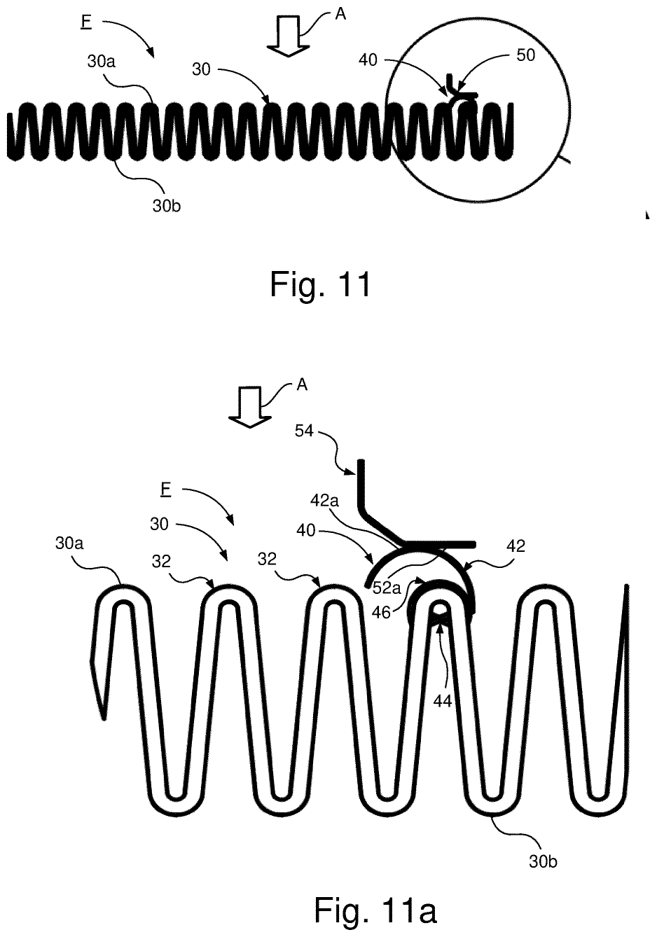

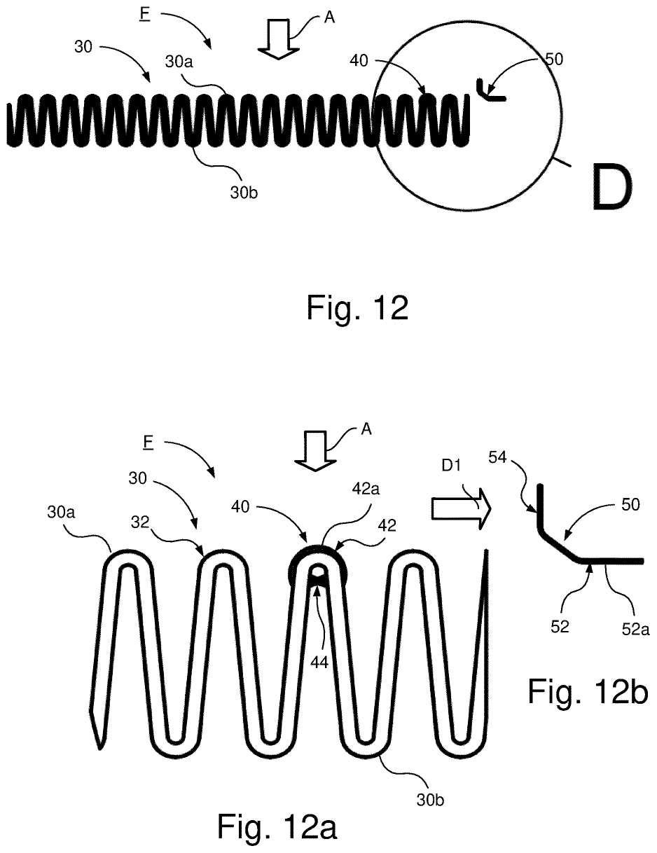

FIG. 11 schematically illustrates a side view of the filter device F and electric device connector 50 in FIG. 10 electrically connected to said filter device F according to an aspect of the present disclosure. FIG. 11a schematically illustrates a side view of a portion of the filter device F in FIG. 11 with the clamp member 40 in FIG. 10a of said filter device F electrically connected to said electric device connector 50 according to an aspect of the present disclosure. FIG. 12 schematically illustrates a side view of a filter device F and an electric device connector 50 of an electric device, not shown, disconnected from said filter device F according to an aspect of the present disclosure; and FIG. 12a schematically illustrates a side view of a portion of the filter device F in FIG. 12 with a clamp member 40 of a filter connection device attached to a filter medium 30 of said filter device F according to an aspect of the present disclosure. FIG. 12b schematically illustrates a side view of the electric device connector 50 in FIG. 12 according to an aspect of the present disclosure.

The filter device F in FIGS. 12 and 12a essentially corresponds to the filter device illustrated in FIGS. 1 and 1a.

According to an aspect, said electric device connector 50 essentially corresponds to the electric device connector in FIG. 10b.

According to an aspect of the present disclosure, said filter medium 30 has deforming properties such that said filter medium 30, when said filter device F is moved towards said electric device such that there is a connection between said clamp member 40 attached to said filter medium 30 and said electric device connector 50, said filter medium 30, where said clamp member 40 is attached, deforms such that said conductive connection between said clamp member 40 and said electric device connector 50 is obtained.

According to an aspect of the present disclosure, said filter medium 30 has elastic deforming properties such that said filter medium 30, when said filter device F is arranged in connection to said electric device within a space of an air duct, strives towards said electric device connector 50 of said electric device, so that said clamp member 40 strives towards said electric device connector 50.

Thus, according to an aspect of the present disclosure, said filter medium 30 has resilient properties such that said filter medium 30, i.e. the pleat 32 of said filter medium 30 to which said clamp member 40 is conductively attached, strives towards said electric device connector 50 of said electric device, when said filter device F is arranged in connection to said electric device within a space of an air duct.

In FIG. 12a said filter device F is moved in the direction of its main extension D1 towards said, in FIG. 12b illustrated, electric device connector 50 of said electric device, not shown.

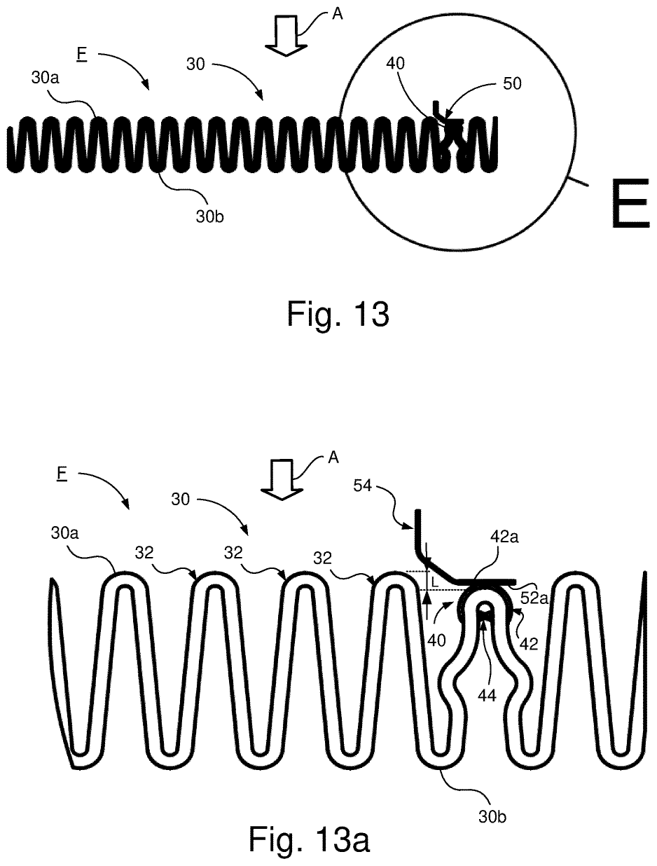

FIG. 13 schematically illustrates a side view of the filter device F and electric device connector 50 in FIG. 12 electrically connected to said filter device F according to an aspect of the present disclosure. FIG. 13a schematically illustrates a side view of a portion of the filter device F in FIG. 13 with the clamp member 40 in FIG. 12a of said filter device F electrically connected to said electric device connector 50 in FIG. 12b according to an aspect of the present disclosure.

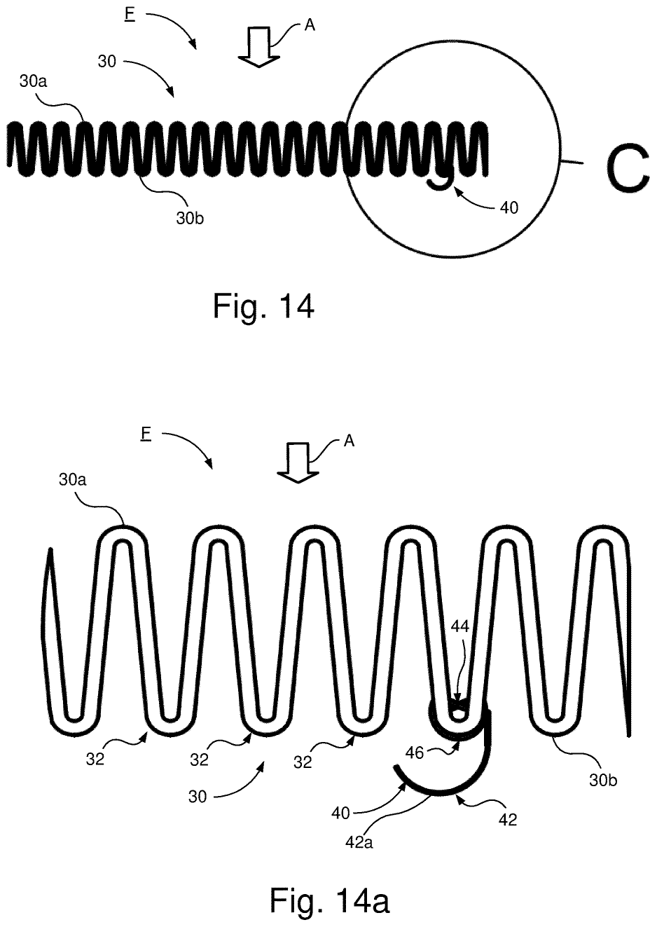

FIG. 14 schematically illustrates a side view of a filter device F according to an aspect of the present disclosure; and FIG. 14a schematically illustrates a side view of a portion of the filter device in FIG. 14 with a clamp member 40 of a filter connection device attached to a filter medium 30 of said filter device F according to an aspect of the present disclosure.

The filter medium 30 of the filter device F in FIGS. 14 and 14a essentially corresponds to the filter medium illustrated in FIGS. 1 and 1a.

The clamp member 40 in FIGS. 14 and 14a essentially corresponds to the clamp member in FIGS. 10 and 10a.

The filter device F in FIGS. 14 and 14a differs from the filter device F in FIGS. 10 and 10a essentially in that said clamp member 40 is attached on the outflow side 30b of said filter medium 30. Said clamp member 40 in FIGS. 14 and 14a is attached in connection to an outflow peak of a pleat 32 of said filter medium 30 on said outflow side 30b.

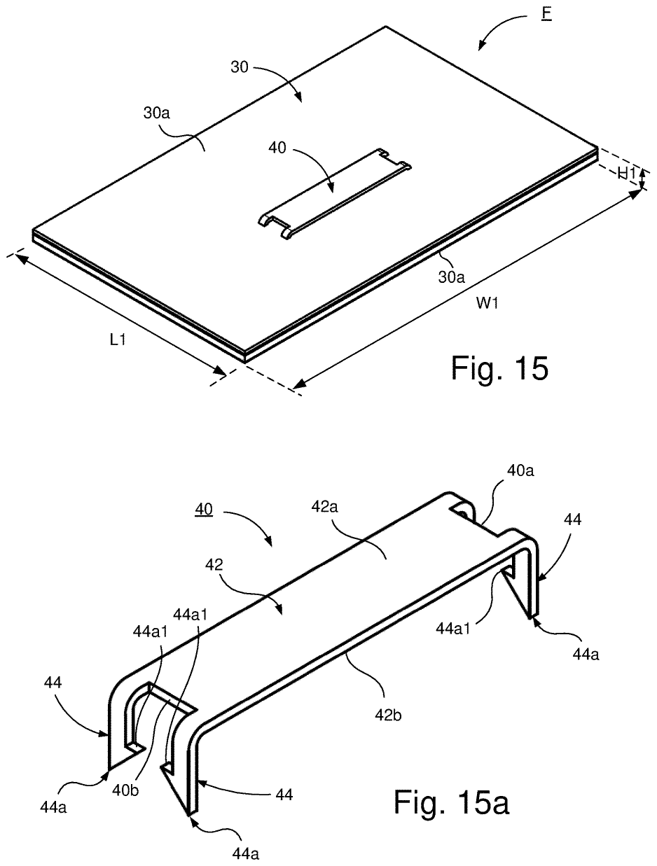

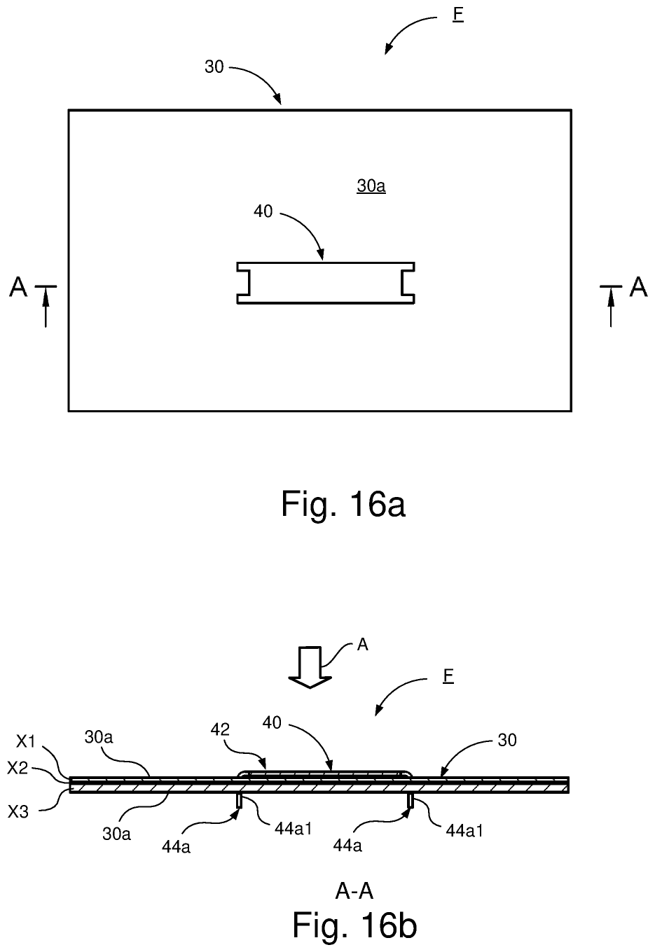

FIG. 15 schematically illustrates a perspective view of a filter device F according to an aspect of the present disclosure; FIG. 16a schematically illustrates a plan view of the filter device F in FIG. 15 according to an aspect of the present disclosure; and, FIG. 16b schematically illustrates a cross-sectional side view of the filter device F in FIG. 16a according to an aspect of the present disclosure.

The filter device F in FIG. 15, 16a-b differs from the filter device F in e.g. FIG. 1-1a in that said filter medium 30 is a plane filter medium 30, and not pleated as in FIG. 1-1a. Thus, said filter medium 30 of the filter device F in FIGS. 15, 16a-b has a flat configuration. Said filter medium 30 has an inflow side 30a configured, during an air purification operation, to face towards the flow of air A and an opposite outflow side 30b, from which purified air having passed through said filter medium 30 is intended to escape.

According to an aspect of the present disclosure, the filter medium 30 has a certain length L1, a certain width W1 and a certain height H1. According to an aspect the height H1 corresponds to the distance between the inflow side 30a and outflow side 30b. According to an aspect of the present disclosure, said width W1 and length L1 has a main extension essentially orthogonal to the height H1. Thus, according to an aspect of the present disclosure said filter medium 30 of said filter device F has an essentially plane main extension.

According to an aspect of the present disclosure, the filter medium 30 has an essentially rectangular configuration with a surrounding edge providing opposite end sides.

The filter medium 30 according to the present disclosure comprises an electrically conductive material X2, schematically illustrated in FIG. 16b. According to an aspect of the present disclosure, the conductive material may form an integral part of the filter medium 30. According to the embodiment in FIG. 16b, the conductive material X2 is an electrically conductive layer X2, such as a carbon filter layer or the like.

According to the embodiment in FIG. 16a, said filter medium 30 comprises a first filter layer X1, and a second layer X2, said second layer X2 being an electrically conductive layer X2 provided by said electrically conductive material X2 of said filter medium 30. According to an aspect of the present disclosure, said first filter layer X1 is a particle filter layer configured to provide filtration of particles in the flow of air during an air purification operation. According to the embodiment in FIG. 16b, said filter medium 30 comprises a third filter layer X3, wherein said second filter layer X2, being an electrically conductive layer X2, is configured to be arranged between said first filter layer X1 and third filter layer X3.

Said filter device F further comprises a filter connection device comprising a clamp member 40 being configured to be conductively attachable to a conductive portion of said filter medium 30. Said clamp member 40 is configured to be conductively attachable to said electrically conductive layer X2. According to an aspect of the present disclosure, said clamp member 40 is configured to be conductively attachable to said electrically conductive layer X2 via said first filter layer X1 and/or said third filter layer X3.

FIG. 15a schematically illustrates a perspective view of the clamp member 40 according to an aspect of the present disclosure. The clamp member 40 comprises a conductive contact portion 42 having a contact surface 42a configured to facilitate conductive connection to an electrically conductive portion of an electric device. The conductive contact portion 42 of the clamp member 40 has an attachment side 42b configured, when said clamp member is attached to said filter medium 30, to face said filter medium 30. Said attachment side 42b is opposite to said a contact surface 42a. According to an aspect of the present disclosure has a longitudinal extension with opposite end sides 40a, 40b.

According to an aspect, said filter device F is configured to be removably introduced into said a compartment of said air duct, not shown. Said clamp member 40 is configured to be attached to said filter medium 30 so that said clamp member 40 of said filter connection device aligns with and electrically connects to an electrically conductive part of an electric device, being fixedly arranged within the air duct.

According to an aspect of the present disclosure, said at least one clamp member 40 comprises a grip portion 44 configured to facilitate attachment and conductive connection of said clamp member 40 to said filter medium 30.

According to an aspect of the present disclosure, said grip portion 44 of said at least one clamp member 40 comprises one or more conductive pins 44a configured to provide conductive connection to conductive parts of said filter medium 30 when attached to the filter medium 30. In the embodiment illustrated in FIG. 15a, said grip portion 44 comprises a set of pins 44a, here four pins 44a, two pins 44a projecting from one end side 40a and two pins 44a projecting from the opposite end side 44b. According to an aspect of the present disclosure, said conductive pins 44a are configured to protrude from said end sides 40a, 40b of said clamp member 40 so as to facilitate efficient conductive connection to and through conductive part, here conductive layer X2, of said filter medium 30, when said clamp member 40 is attached to said filter medium 30.

According to an aspect of the present disclosure, said grip portion 44 of said at least one clamp member 40 comprises retention members 44a1 configured to facilitate retention of said at least one clamp member 40 when said clamp member 40 is attached to said filter medium 30.

According to an aspect of the present disclosure, said conductive pins 44a constitute or comprise said retention members 44a1. According to an aspect of the present disclosure, as illustrated in FIG. 15a, said conductive pins 44a comprises retention members 44a1, where said retention members 44a1 of said conductive pins are constituted by one barbs 44a1 on one said o pins 44a. According to an aspect of the present disclosure, as illustrated in FIG. 16b, said conductive pins 44a, when said clamp member 40 is attached to said filter medium 30, are configured to run through said filter medium 30 from the inflow side 30a through the outflow side 30b such that said retention members 44a1, i.e. barbs, retain said clamp member 40 at said filter medium 30.

Although the detailed description above describes variants of filter devices, filter medium, clamp members, the main purpose and general function is essentially the same. Therefore, the same reference characters have been utilized for e.g. filter medium, clamp member etc. throughout the several views. The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications suited to the particular use contemplated.

1. A filter device for filtration of an air flow, said filter device comprising:
a filter medium, said filter medium comprising an electrically conductive material; and,
a filter connection device comprising an electrically conductive material, said filter connection device comprising at least one clamp member being configured to be conductively attachable to a conductive portion of said filter medium so that, when said at least one clamp member is attached to said filter medium, said filter medium, by means of said filter connection device is allowed to be removably electrically connectable to at least one electrically conductive portion of an electric device so as to, when electrically connected, facilitate an air purification operation.

2. A filter device according to claim 1, wherein said filter medium has an inflow side configured, during an air purification operation, to face towards the flow of air and an opposite outflow side.

3. A filter device according to claim 1, wherein said filter device is configured to be removably introduced via an opening into a compartment of an air duct, wherein said at least one clamp member is configured to be attached to said filter medium so that said filter connection device aligns with and electrically connects to said at least one electrically conductive portion of said electric device being fixedly arranged within said air duct.

4. A filter device according to claim 3, wherein said filter device has an essentially plane main extension, wherein said at least one clamp member is configured to be attached to said filter medium so that said filter device may be introduced, by moving the filter device in the direction of its main extension, into said compartment of said air duct, for facilitating said electrical connection to said at least one electrically conductive portion of said electric device, and removed from said compartment by moving said filter device in the direction of its main extension so that said at least one clamp member of said filter device is disconnected from said at least one electrically conductive portion of said electric device

5. A filter device according to claim 1, wherein said at least one clamp member comprises a conductive contact portion having a contact surface configured to facilitate conductive connection to said electrically conductive portion of said electric device.

6. A filter device according to claim 1, wherein said at least one clamp member; comprises a grip portion configured to facilitate attachment and conductive connection of said at least one clamp member to said filter medium.

7. A filter device according to claims 1-6, wherein said at least one clamp member has resilient properties so as to strive towards said at least one electrically conductive portion of an electric device, when arranged in connection to said electric device

8. A filter device according to claim 6, wherein said grip portion of said at least one clamp member comprises one or more conductive pins configured to provide conductive connection to conductive parts of said filter medium when attached to the filter medium.

9. A filter device according to claims 1-8, wherein said filter medium comprises at least two layers, said at least two layers comprising a first filter layer, and a second layer, said second layer being an electrically conductive layer provided by said electrically conductive material of said filter medium-said at least one clamp member being configured to be conductively attachable to said electrically conductive layer.

10. A filter device according to claim 2, wherein said filter medium has a pleated configuration with a set of pleats, wherein said at least one clamp member is configured to be attachable to one or more of said set of pleats of said filter medium.

11. filter device according to claim 10, wherein at least one of said at least one clamp member is configured to be attached on said inflow side, of said filter medium.

12. A filter device according to claims 1-10, wherein said filter device comprises an edge member configured to at least partly surround said filter medium.

13. A filter device according to claims 1-11, wherein the electric device is configured to be operated so that different electrical potentials are applied, wherein one electrical potential of said different electrical potentials is configured to be applied to said at least one electrically conductive portion of said electric device-and another electrical potential of said different electrical potentials, different from said one electrical potential, is configured to be applied to another at least one electrically conductive portion of said electric device.

14. An electric device comprising at least one electrically conductive portion for electrical connection to a filter connection device of a filter device-according to claims 1-13, for providing an air purification operation.

15. The electric device according to claim 14, wherein said electric device comprises an electric device connector comprising or being operably connectable to said electrically conductive portion of said electric device for facilitating said electrical connection with said at least one clamp member of said filter connection device.

16. The electric device according to claim 15, wherein said electric device connector has resilient properties so as to strive towards said at least one clamp member of said filter connection device when electrically connected to said filter connection device.

17. An air purification device for separating airborne particles from a flow of air in an air duct, the air purification device comprising a filter device according to claim 1-13, and an electric device according to claims 14-16.
